(19) United States
(12) Patent Application Publication
(10) Pub. No.: US 2025/0098916 A1
(43) Pub. Date: Mar. 27, 2025

(54) HAIR CUTTING ASSEMBLY, CLEANING DEVICE AND CUTTING CONTROL METHOD

(71) Applicants: JIANGSU MIDEA CLEANING APPLIANCES CO., LTD., SUZHOU (CN); MIDEA GROUP CO., LTD., FOSHAN (CN)

(72) Inventors: Hui GUO, SUZHOU (CN); Ming LIU, SUZHOU (CN); Manman CHEN, SUZHOU (CN); Ruochen CHAO, SUZHOU (CN)

(21) Appl. No.: 18/580,618

(22) PCT Filed: Jul. 28, 2023
(86) PCT No.: PCT/CN2023/110018

§ 371 Date: Jan. 19, 2024

(30) Foreign Application Priority Data
Nov. 17, 2022 (CN) 202211439279.4
Nov. 17, 2022 (CN) 202223054355.8
Nov. 17, 2022 (CN) 202223058917.6
Nov. 17, 2022 (CN) 202223085093.1

(51) Int. Cl. A47L 9/04; A47L 7/00; A47L 9/28

(52) U.S. Cl. CPC A47L 9/0477; A47L 7/0066; A47L 9/2831; A47L 9/2836

(57) ABSTRACT

The present disclosure provides a hair cutting assembly, a cleaning device and a cutting control method, and the hair cutting assembly includes a housing; a rolling brush connected to the housing, and the rolling brush comprises a rotating axis and is able to rotate with respect to the housing along the rotating axis; a fixed blade, connected to the housing, and the fixed blade is fixed relative to the housing; a movable blade, connected to the housing, and the movable blade can move with respect to the fixed blade, the movable blade abuts on the fixed blade and the fixed blade is adjacent to the movable blade with respect to the circumferential direction of the rolling brush.

### CROSS-REFERENCES TO RELATED APPLICATIONS

The present disclosure is a national phase application of International Application No. PCT/CN2023/110018, filed on Jul. 28, 2023, which claims priority to Chinese Patent Application No. 202223054355.8 filed with China National Intellectual Property Administration on Nov. 17, 2022, Chinese Patent Application No. 202211439279.4 filed with China National Intellectual Property Administration on Nov. 17, 2022, Chinese Patent Application No. 202223085093.1 filed with China National Intellectual Property Administration on Nov. 17, 2022, and Chinese Patent Application No. 202223058917.6 filed with China National Intellectual Property Administration on Nov. 17, 2022, the entire contents of which are herein incorporated by reference.

### FIELD

This disclosure relates to the field of cleaning devices, and in an embodiment, relates to a hair cutting assembly, a cleaning device and a cutting control method.

### BACKGROUND

Currently, cleaning devices such as a vacuum cleaner are widely used and gradually go into each household. The main working part of the cleaning head of the vacuum cleaner is a rotary rolling brush, and the rolling brush contacts the ground, beats the dust on the ground and brushes the dust up. Elongate fibrous wastes such as hair easily wind the rolling brush, and this affects the cleaning effect of the rolling brush and can hardly be cleared.

In the cleaning devices in related technologies, a blade is configured to cut off the fibrous wastes winding the rolling brush, then the winding is solved and the fibrous wastes are absorbed. However, when the cleaning devices performs the cleaning operation, the wastes rotating with the rolling brush will accelerate the damage to the blade, and then affect the cutting effect of the blade to the fibrous wastes.

### SUMMARY

In order to solve or improve at least one of the above problems, one purpose of the present disclosure is to provide a hair cutting assembly.

Another purpose of the present disclosure is to provide a cleaning device including the above hair cutting assembly.

Another purpose of the present disclosure is to provide a cutting control method.

In order to achieve the above purposes, the embodiment of the present disclosure provides a hair cutting assembly, including: a housing; a rolling brush connected to the housing, and the rolling brush comprises a rotating axis and can rotate with respect to the housing along the rotating axis; a fixed blade, connected to the housing, and the fixed blade is fixed relative to the housing; a movable blade, connected to the housing, and the movable blade can move with respect to the fixed blade, the movable blade abuts on the fixed blade, and the fixed blade is adjacent to the movable blade with respect to the circumferential direction of the rolling brush; and in the cross section of the rolling brush, a sixth distance between the rotating axis and a plane where the fixed blade abuts on the movable blade is less than a maximum radius size of the rolling brush, and the sixth distance is not zero.

In the present disclosure the sixth distance between the rotating axis and the plane where the fixed blade abuts on the movable blade is less than the maximum radius size of the rolling brush, and the sixth distance is not zero; as the sixth distance is not zero, a cutting surface does not extend completely along the radial direction of the rolling brush, and this prevents the blade from pointing at the axis completely and can reduce the amount of the wastes striking the blade perpendicularly, and then protect the blade. In addition, through limiting the sixth distance to be less than the maximum radius size of the rolling brush, the blade will be aligned with the rolling brush after the blade extends along the direction of the tip of the blade, and then when the rolling brush is wound by hair, it is more convenient to contact the cutting surface to cut, then the hair that is thrown along the tangential direction of the rolling brush can be cut, and the striking force on the blade from the wastes is reduced on the basis of ensuring cutting the hair effectively.

A embodiment of the present disclosure provides a hair cutting assembly, including: a housing; a rolling brush, connected to the housing, and the rolling brush can rotate along a rotating axis with respect to the housing; a fixed blade, connected to the housing, and the fixed blade is fixed with respect to the housing; a movable blade, connected to the housing, and the movable blade can move with respect to the fixed blade, the fixed blade is adjacent to the movable blade with respect to the circumferential direction of the rolling brush; when the plane where the rotating axis is located rotates with the rolling brush along a first rotating direction, the plane passes the fixed blade and the movable blade successively.

According to the embodiment of the hair cutting assembly provided by the present disclosure, when the wastes rotate with the rolling brush along its rotating direction, the fixed blade that does not move is first contacted, and the movable blade can be protected in a certain extent, the damage to the movable blade from the wastes is lowered, the effective use period of the movable blade is ensured, and this helps improve the cutting effect of the movable blade to the fibrous wastes.

In an embodiment, the hair cutting assembly comprises the housing, the rolling brush, the fixed blade and the movable blade. And the rolling brush, the fixed blade and the movable blade are all connected to the housing, and the housing mainly plays a role of a mounting carrier. In some embodiments, the rolling brush can rotate with respect to the housing along the rotating axis. In a further embodiment, the rolling brush comprises a roller and multiple rows of bristles provided at the circumferential side wall of the roller. The rotating axis of the rolling brush can be understood as the rotating axis of the roller. The rotation of the rolling brush is substantially that the roller brings the bristles to rotate. When a cleaning device performs a cleaning operation, the rolling brush contacts the ground, the bristles of the rolling brush beat the dust on the ground and brush the wastes up, and sweep the wastes into the housing.

In some embodiments, the fixed blade is fixed with respect to the housing. The movable blade can move with respect to the fixed blade. In a further embodiment, the movable blade abuts on the fixed blade. In a further embodiment, the movable blade comprises a first working position and a second working position. The movable blade can move from the first working position to the second working position or from the second working position to the first working position. In a further embodiment, the movable blade moves and cuts along the rotating axis of the rolling brush. The movable blade moves between the first working position and the second working position with respect to the fixed blade, the relative motion of the movable blade and the fixed blade forms an effective cutting action, and then the fibrous wastes (for example, the hair winding the rolling brush) are cut. In a further embodiment, the housing comprises a mounting housing, a first support housing and a second support housing. The rolling brush is connected to the mounting housing, and can rotate with respect to the mounting housing along the rotating axis. The fixed blade is connected to the first support housing, and the movable blade is connected to the second support housing. The first support housing is connected to the mounting housing, and the second support housing is connected to the mounting housing. The connecting method between the first support housing and the mounting housing is bonding, welding, etc.; and the connecting method between the second support housing and the mounting housing is bonding, welding, etc.

In some embodiments, the fixed blade is adjacent to the movable blade with respect to the circumferential direction of the rolling brush. In a further embodiment, the fixed blade and the movable blade are located at the same side of a plane. When the plane where the rotating axis of the rolling brush is located rotates with the rolling brush along a first rotating direction, the plane passes the fixed blade and the movable blade successively. When the wastes rotate with the rolling brush along its rotating direction, the fixed blade that does not move is first contacted, and the movable blade can be protected in a certain extent, the damage to the movable blade from the wastes is lowered, the effective use period of the movable blade is ensured, and this helps improve the cutting effect of the movable blade to the fibrous wastes.

A embodiment of the present disclosure provides a hair cutting assembly, including: a driving member, provided with an eccentric column at one side; a movable blade, in transmission connection with the driving member through the eccentric column; a cushion block, provided on the movable blade and provided with a driven part, and the eccentric column extends into the driven part or extends into a first limiting hole of the movable blade and the driven part.

The hair cutting assembly mainly comprises the driving member, the eccentric column and the movable blade, the driving member plays a role of providing an active force, and will drive the movable blade to do reciprocating motion under the effect of driving the eccentric column, and thus cutting the hair is achieved. The driving member is in transmission connection with the movable blade, and in an embodiment, the driving member will bring the eccentric column provided at one side to rotate, the movable blade is provided with the first limiting hole, through extending the eccentric column into the first limiting hole, the movable blade can be made to move along a second direction during the rotating.

In some embodiments, the eccentric column extends into the driven part and the movable blade moves along the second direction, while the present disclosure does not define whether the movable blade is provided with the first limiting hole.

It needs to be emphasized that the movable blade is provided with the cushion block, through providing the driven part on the cushion block, when the eccentric column brings the movable blade to move, it will further bring the cushion block to move under the effect of the driven part; it is understandable that the cushion block moves together with the movable blade, providing the cushion block on the movable blade can increase the contact area between the eccentric column and the movable blade, therefore the torque acting on the movable blade is reduced, that is, the force totally acts on the movable blade, and the thicker the movable blade is, the higher the transmission efficiency of the force is and the smaller the abrasion is, however, what follows is the increase of the thickness of the single movable blade, and this does not help processing, while the present disclosure connects the cushion block with the movable blade through providing the cushion block on the movable blade, uses the cushion block to increase the contact area between the movable blade and the eccentric column in a changed way, and then the lowering of abrasion is achieved.

It needs to be added that the extending of the eccentric column into the first limiting hole mentioned in the present disclosure is only a relative position relation, and what directly contacts the eccentric column is the cushion block. In some embodiments, the cushion block and the first limiting hole can directly contact the eccentric column at the same time.

And the movable blade extends along the second direction, the first limiting hole extends along a first direction perpendicular to the second direction, for example, the movable blade moves laterally, the first limiting hole is arranged vertically, and the eccentric column will cooperate with the first limiting hole when the eccentric column rotates, and then the movable blade moves along the second direction.

It can be understood that a separated cushion block is used, and thus a relatively light wear-resistant material can be selected as the material of the cushion block, thus, compared with a solution of conducting thickening treatment to the blade directly, the mass is lowered in a certain extent, and the wear resistance is enhanced at the same time, and product competitiveness is improved greatly.

In addition, if abrasion occurs, as the cushion block is provided at the side of the movable blade away from the fixed blade, the cushion block is located at the end portion of the movable blade, it will first have abrasion, and can be replaced separately at this time, and then the maintenance cost is lowered.

It can be understood that the position of the fixed blade is fixed, the movable blade is in indirect connection with the driving member through the eccentric column, under the joint effect of the eccentric column and the first limiting hole, the movable blade can be made to move with respect to the fixed blade, and thus the cutting effect to the hair is achieved.

It needs to be added that the fixed blade and the movable blade are provided adjacent to each other, to achieve the cutting under the effect of an edge portion when the movable blade moves.

In some embodiments, the driving member can adopt an ordinary motor or a gear motor.

A embodiment of the present disclosure provides a hair cutting assembly, including: a driving member; an active member, connected to the driving shaft of the driving member; a transmitting wheel, engaging with the active member, and the axis of the transmitting wheel is not parallel to the axis of the driving shaft; an eccentric column, connected to the transmitting wheel; a movable blade, provided on the eccentric column; and the transmitting wheel rotates and makes the movable blade do reciprocating motion through the cooperation of the movable blade and the eccentric column.

The hair cutting assembly provided by the present disclosure mainly comprises the driving member, the active member and the transmitting wheel, the driving member plays a role of providing an active force, the active member and the transmitting wheel are used as retarders and finally convert the rotation of the driving member into the lateral driving to the movable blade. In an embodiment, the active member is directly sleeved on the driving shaft, the driving shaft rotates and will bring the active member to rotate at the same time, under the effect of the engagement of the active member and the transmitting wheel, the transmitting wheel is further made to rotate; as the axis of the transmitting wheel is not parallel to the axis of the driving shaft, in the case that the movable blade is provided on the eccentric column, the axis of the transmitting wheel is not parallel to the movable blade, either, on this basis, as the structure of the active member is adopted, the axis of the active member can be made to be parallel to the extending direction of the movable blade substantially, thus this will limit the position of the driving member, and the driving member is staggered in a direction substantially perpendicular to the extending plane of the movable blade, and by the substantially parallel position, the size of the overall driving member in a thickness direction, that is, the size in the axial direction of the transmitting wheel, is reduced in a certain extent.

A embodiment of the present disclosure provides a cleaning device, including: the hair cutting assembly in any of the above embodiments; a first driving member, connected to the rolling brush of the hair cutting assembly, and the first driving member is configured to drive the rolling brush to rotate along its axis; a second driving member, connected to the movable blade of the hair cutting assembly, and the second driving member is configured to drive the movable blade to move with respect to the fixed blade of the hair cutting assembly; and a controller, connected to the first driving member, and the controller is connected to the second driving member.

And the cleaning device comprises, while is not limited to, a vacuum cleaner, a floor scrubber, a sweeping robot and the like that can collect and clean the dust and hair on the floor.

The controller can limit the movable blade to move with respect to the fixed blade when the cleaning device just starts to conduct cleaning operation, and limit the movable blade to stop automatically after it moves for a period of time.

The controller can limit the movable blade to keep static with respect to the fixed blade all the time when the cleaning device is conducting cleaning operation.

When the controller limits the movable blade to move with respect to the fixed blade, the cleaning device does not conduct the cleaning operation.

When controller controls the movable blade to move with respect to the fixed blade, the rolling brush of the cleaning device rotates, and the rotating direction is opposite to the rotating direction of the rolling brush when the cleaning device conducts the cleaning operation.

In some embodiments, the cleaning device further comprises: a detecting device, connected to the controller, and configured to detect the amount of the wastes that are adhered to or wind the rolling brush, and the controller is configured to determine that the rolling brush of the cleaning device is in a working state, and limit the movable blade to be in a moving state when the detecting device determines that the amount of the wastes on the rolling brush is greater than a first threshold; or the controller is configured to limit the movable blade to be in a moving state, and limit the movable blade to stop moving when the detecting device determines that the amount of the wastes on the rolling brush is less than a second threshold, and the second threshold is not greater than the first threshold.

In some embodiments, the detecting device is connected to the housing of the hair cutting assembly, and the detecting device is an optical recognition camera; or the detecting device is connected to the first driving member and is configured to detect the current value of the first driving member.

In some embodiments, the cleaning device further comprises: a first storage container, connected to the housing of the hair cutting assembly, and the first storage container is configured to store a cleaning liquid, and communicates with the cavity of the hair cutting assembly; and a second storage container, connected to the housing, and the second storage container is configured to store the wastes and sewage, and communicates with the cavity of the hair cutting assembly.

The embodiments of the present disclosure provides a cutting control method for the above cleaning device, and the cutting control method comprises: acquiring the operating mode of the cleaning device; determining the rotating parameters of the rolling brush and the motion parameters of the movable blade based on the operating mode; controlling the rotation of the rolling brush through the first driving member based on the rotating parameters; and controlling the motion of the movable blade with respect to the fixed blade through the second driving member based on the motion parameters.

In the embodiments of the present disclosure, the operating mode is first acquired, corresponding rotating parameters and motion parameters can be determined based on different operating modes, and the rotating parameters and the motion parameters comprise, while are not limited to, a rotating speed, a rotating direction, a rotating frequency, a moving distance, a moving speed, etc. Then the motion of the rolling brush and the movable blade are controlled respectively based on the rotating parameters and the motion parameters, and thus operations in different modes can be achieved.

In some embodiments, the cutting control method further comprises: detecting the amount of the wastes adhered to or winding the rolling brush by the detecting device; determining that the rolling brush is in a working state, and limiting the movable blade to be in a moving state when the amount of the wastes on the rolling brush determined by the detecting device is greater than a first threshold; or limiting the movable blade to be in a moving state, and limiting the movable blade to stop moving when the amount of the wastes on the rolling brush determined by the detecting device is less than a second threshold; and the second threshold is not greater than the first threshold.

The embodiments of the present disclosure will be clear in the following description, or can be understood through the practice of the present disclosure.

### BRIEF DESCRIPTION OF THE DRAWINGS

FIG. 1 is a first schematic view of the structure of a hair cutting assembly according to an embodiment of the present disclosure;

FIG. 2 is a schematic view of the structure of a rolling brush according to an embodiment of the present disclosure;

FIG. 3 is a schematic view of the structure of a movable blade and a fixed blade according to an embodiment of the present disclosure;

FIG. 4 is a schematic view of the structure of a rolling brush according to an embodiment of the present disclosure;

FIG. 5 is a first schematic view of the structure of a cleaning device according to an embodiment of the present disclosure;

FIG. 6 is a second schematic view of the structure of a cleaning device according to an embodiment of the present disclosure;

FIG. 7 is a first schematic block diagram of a cleaning device according to an embodiment of the present disclosure;

FIG. 8 is a second schematic block diagram of a cleaning device according to an embodiment of the present disclosure;

FIG. 9 is a third schematic block diagram of a cleaning device according to an embodiment of the present disclosure;

FIG. 10 is a schematic view of the structure of a movable blade and a fixed blade according to an embodiment of the present disclosure;

FIG. 11 is a schematic flow chart of a cutting control method according to an embodiment of the present disclosure;

FIG. 12 is a schematic view of the structure of a rolling brush according to an embodiment of the present disclosure;

FIG. 13 is a second schematic view of the structure of a hair cutting assembly according to an embodiment of the present disclosure;

FIG. 14 is a third schematic view of the structure of a hair cutting assembly according to an embodiment of the present disclosure;

FIG. 15 is a fourth schematic view of the structure of a hair cutting assembly according to an embodiment of the present disclosure;

FIG. 16 is a schematic view of the structure of a movable blade and a fixed blade according to an embodiment of the present disclosure;

FIG. 17 is a schematic view of the structure of a first comb tooth and a second comb tooth according to an embodiment of the present disclosure;

FIG. 18 is a fifth schematic view of the structure of a hair cutting assembly according to an embodiment of the present disclosure;

FIG. 19 is a sixth schematic view of the structure of a hair cutting assembly according to an embodiment of the present disclosure;

FIG. 20 is a first schematic view of the structure of a cushion block according to an embodiment of the present disclosure;

FIG. 21 is a second schematic view of the structure of a cushion block according to an embodiment of the present disclosure;

FIG. 22 is a schematic view of the structure of a driving assembly according to an embodiment of the present disclosure;

FIG. 23 is a seventh schematic view of the structure of a hair cutting assembly according to an embodiment of the present disclosure;

FIG. 24 is an eighth schematic view of the structure of a hair cutting assembly according to an embodiment of the present disclosure;

FIG. 25 is a second schematic view of the structure of a movable blade and a fixed blade according to an embodiment of the present disclosure;

FIG. 26 is a fourth schematic view of the structure of a cleaning device according to an embodiment of the present disclosure; and

FIG. 27 is a fifth schematic view of the structure of a cleaning device according to an embodiment of the present disclosure.

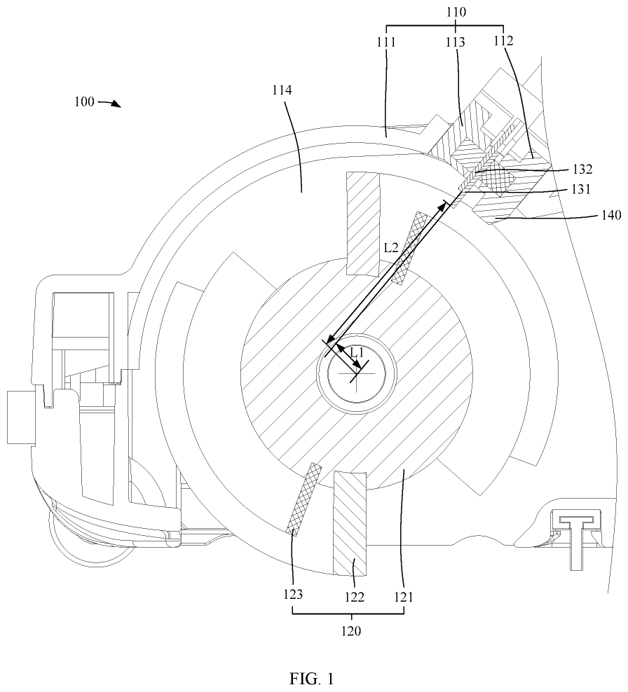

And the corresponding relations between the reference signs and the component names in FIG. 1 to FIG. 10 and FIG. 12 to FIG. 27 are as follow:
100 hair cutting assembly; 102 driving member; 1022 driving shaft; 104 active member; 106 transmitting wheel; 108 eccentric wheel; 1082 eccentric column; 109 cushion block; 1092 driven part; 1094 protruding portion; 1096 second limiting hole; 1098 third limiting hole; 131 fixed blade; 1312 first cutter tooth; 1314 first blade; 1316 second blade; 132 movable blade; 1322 second cutter tooth; 1324 first limiting hole; 2062 first housing; 2064 second housing; 2082 support member; 2084 sliding bar; 2102 first pin hole; 2104 second pin hole; 2106 connecting member; 2122 first comb tooth; 2124 second comb tooth; 214 fourth limiting hole; 216 bearing; 110 housing; 111 mounting housing; 112 first support housing; 113 second support housing; 114 cavity; 120 rolling brush; 121 roller; 122 bristle; 123 sheet; 140 comb tooth; 150 shielding portion; 160 guiding portion; 4110 transmitting rod; 41102 limiting hole; 4112 reduction housing; 4114 transmitting shaft; 206 cutting housing; 208 torsion spring structure; 2142 first magnetic member; 2144 second magnetic member;
200 cleaning device; 211 first driving member; 212 second driving member; 220 controller; 230 detecting device; 241 independent switch; 242 remote control switch; 251 first storage container; 252 second storage container; 302 device housing

### DETAILED DESCRIPTION OF THE DISCLOSURE

To more clearly understand the above embodiments of the present disclosure, the present disclosure will be further detailed hereinafter in combination with the accompanying drawings and embodiments. It should be indicated that in the case of no conflict, the embodiments and the features in the embodiments of the present disclosure can be combined with each other.

Many details are illustrated in the following description for the convenience of a thorough understanding to the present disclosure, but the present disclosure can further be implemented using other embodiments other than these described herein. Therefore, the protection scope of the present disclosure is not limited to the specific embodiments disclosed in the following text.

Some embodiments according to the present disclosure are described hereinafter by referring to FIG. 1 to FIG. 27.

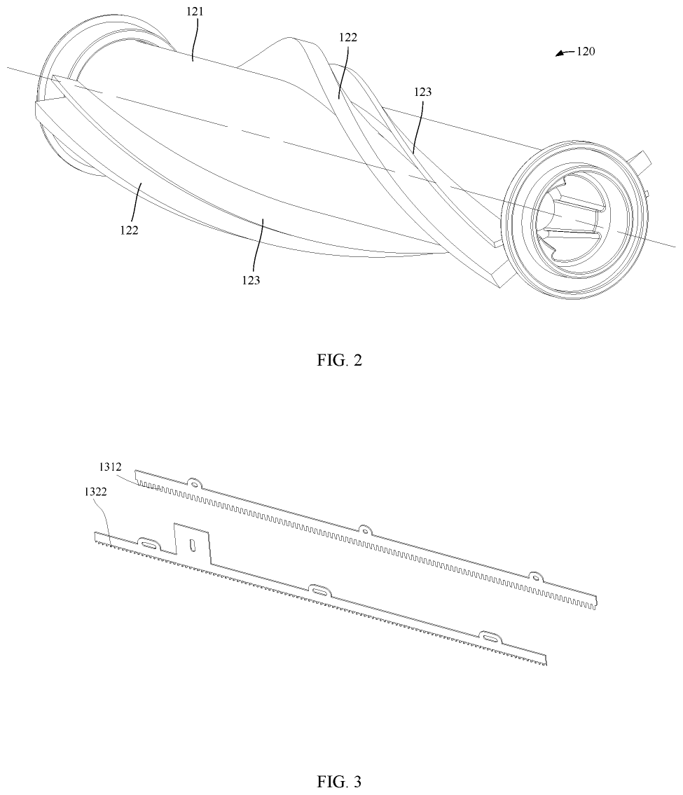

As shown in FIG. 1, a hair cutting assembly 100 provided in an embodiment according to the present disclosure comprises a housing 110, a rolling brush 120, a fixed blade 131 and a movable blade 132. And the rolling brush 120, the fixed blade 131 and the movable blade 132 are all connected to the housing 110, and the housing 110 mainly plays a role of a mounting carrier. In some embodiments, the rolling brush 120 can rotate with respect to the housing 110 along its rotating axis. In a further embodiment, as shown in FIG. 2, the rolling brush 120 comprises a roller 121 and multiple rows of bristles 122 provided at the circumferential side wall of the roller. The rotating axis of the rolling brush 120 can be understood as the rotating axis of the roller 121. The rotation of the rolling brush 120 is substantially that the roller brings the bristles 122 to rotate. When a cleaning device performs a cleaning operation, the rolling brush 120 contacts the ground, the bristles 122 of the rolling brush 120 beat the dust on the ground and brush the wastes up, and sweep the wastes into the housing 110.

In some embodiments, the fixed blade 131 is fixed with respect to the housing 110. The movable blade 132 can move with respect to the fixed blade 131. The movable blade 132 abuts on the fixed blade 131. In a further embodiment, the movable blade 132 comprises a first working position and a second working position. The movable blade 132 can move from the first working position to the second working position or from the second working position to the first working position, and the movable blade 132 is close to or away from the rolling brush 120. The movable blade 132 moves between the first working position and the second working position with respect to the fixed blade 131, the relative motion of the movable blade 132 and the fixed blade 131 forms an effective cutting action, and then the fibrous wastes (for example, the hair winding the rolling brush 120) are cut. In a further embodiment, the housing 110 comprises a mounting housing 111, a first support housing 112 and a second support housing 113. The rolling brush 120 is connected to the mounting housing 111, and can rotate with respect to the mounting housing 111 along its rotating axis. The fixed blade 131 is connected to the first support housing 112, and the movable blade 132 is connected to the second support housing 113. The first support housing 112 is connected to the mounting housing 111, and the second support housing 113 is connected to the mounting housing 111. The connecting method between the first support housing 112 and the mounting housing 111 is bonding, welding, etc.; and the connecting method between the second support housing 113 and the mounting housing 111 is bonding, welding, etc.

It needs to be emphasized that in the present disclosure a sixth distance L1 between the rotating axis and the plane where the fixed blade 131 abuts on the movable blade 132 is less than the maximum radius size of the rolling brush 120, and the sixth distance is not zero, and thus a cutting surface will extend into the rolling brush 120 obliquely; as the sixth distance is not zero, the cutting surface does not extend completely along the radial direction of the rolling brush 120, and this prevents the blade from pointing at the axis completely and can reduce the amount of the wastes striking the blade perpendicularly, and then protect the blade. In addition, through limiting the sixth distance to be less than the maximum radius size of the rolling brush 120, the blade will be aligned with the rolling brush after the blade extends along the direction of the tip of the blade, and then when the rolling brush 120 is wound by hair, it is more convenient to contact the cutting surface to cut, then the hair that is thrown along the tangential direction of the rolling brush can be cut, and the striking force on the blade from the wastes is reduced on the basis of ensuring cutting the hair effectively.

In some embodiments, a comb tooth 140 is provided on the housing 110, and then some large particles of wastes can be filtered and shielded, in an embodiment, the relative position of the comb tooth 140 and the two types of blades is that the comb tooth 140 is located at the outermost side, the fixed blade 131 is located in the middle and the movable blade 132 is located at the innermost side, when the rolling brush 120 rotates, it will pass the comb tooth 140, the fixed blade 131 and the movable blade 132 successively, and the comb tooth 140 and the fixed blade 131 can have protecting effect to the moving movable blade 132.

In some embodiments, the comb tooth 140 can be provided in the right upper corner in FIG. 1.

And the relative position of the comb tooth 140 and the fixed blade 131 will be staggered by 25 degrees, that is, the circumferential angle presented between the end of the comb tooth 140 facing the rolling brush 120 and the end of the fixed blade 131 facing the roller brush 120, and the rotating axis of the rolling brush 120 is not greater than 25 degrees, to provide a suitable space and then to conveniently collect articles such as dust and hair.

In some embodiments, through limiting the specific ratio of the maximum radius size to a first distance, the ratio of the two is limited to be greater than or equal to 1.1, thus, when the rolling brush 120 is wound by hair, it is more convenient to contact the cutting surface to cut, and the long use of the hair cutting assembly is ensured.

As shown in FIG. 1, the hair cutting assembly 100 provided in an embodiment according to the present disclosure comprises the housing 110, the rolling brush 120, the fixed blade 131 and the movable blade 132. And the rolling brush 120, the fixed blade 131 and the movable blade 132 are all connected to the housing 110, and the housing 110 mainly plays a role of a mounting carrier. In some embodiments, the rolling brush 120 can rotate with respect to the housing 110 along its rotating axis. In a further embodiment, the rolling brush 120 comprises the roller and multiple rows of bristles 122 provided at the circumferential side wall of the roller. The rotating axis of the rolling brush 120 can be understood as the rotating axis of the roller. The rotation of the rolling brush 120 is substantially that the roller brings the bristles 122 to rotate. When a cleaning device performs a cleaning operation, the rolling brush 120 contacts the ground, the bristles 122 of the rolling brush 120 beat the dust on the ground and brush the wastes up, and sweep the wastes into the housing 110.

And as shown in FIG. 2 and FIG. 4, the rolling brush 120 in an embodiment comprises the roller 121, the bristles 122 and a sheet 123, the roller 121 serves as the base of the bristles 122 and the sheet 123, the roller 121 is in rotating connection with the housing 110, through providing the bristles 122 on the outer side wall of the roller 121 spirally, it is convenient to collect the dust, wastes, hair, etc. On this basis, the roller 121 can further be provided with the sheet 123 parallel to the bristles 122, thus the hair can be jacked up, and this prevents winding the roller 121 directly, which results in that normal cleaning cannot be conducted.

And for the positions of the blades, the sheet 123 and the bristles 122, a second distance L2 between the end portions of the fixed blade 131 and the movable blade 132 and the axis of the rotating axis will be greater than the maximum radius size of the sheet 123 and less than the maximum radius size of the bristles 122, that is, the second distance is greater than a second maximum radius size and less than a first maximum radius size, for the second distance, it should be between the first maximum radius size and the second maximum radius size.

It needs to be added that the second maximum radius size is less than the first maximum radius size, that is, the radial length of the bristles 122 is larger, while the sheet 123 is slightly shorter than the radial length of the bristles 122.

Through providing the bristles and the sheets adjacent to each other in the circumferential direction of the roller, it is convenient to support the structures, such as hair, which easily wind the roller under the effect of the sheet, and then this helps the cutting of the movable blade.

When the plane where the rotating axis is located rotates with the rolling brush along a first rotating direction, the plane successively passes the bristles and the sheet. In some embodiments, if most of the parts of the rolling brush do not move, each row of bristles rotates about the rotating axis of the rolling brush along a second rotating direction by 40 degrees at most, and then will contact a sheet (suppose that the first rotating direction is the rotating direction of the rolling brush when it conducts normal cleaning operation, and the second rotating direction is a direction opposite to it).

Particularly, through defining the size relation between the second maximum radius size, the first maximum radius size and the second distance, it is defined that the second distance is between the second maximum radius size and the first maximum radius size, and the blade can effectively cut the hair on the bristles, and will not act on the sheets at the same time, and then the damage due to the direct contact between the sheet and the blade is lowered.

In an embodiment, one sheet 123 will be provided at one side of each bristle 122, and thus corresponding hair supporting effect is achieved.

In another embodiment, one sheet 123 is respectively provided at the two sides of each bristle 122, no matter how the rolling brush 120 rotates, the supporting effect to the hair can be achieved.

When the rolling brush rotates a circle, the area enveloped by the rotation of each bristle at least partially overlaps the area enveloped by the rotation of one sheet.

It needs to be added that for the bristles 122 and the sheet 123, the plane where the rotating axis is located is limited to first pass the bristles 122 and then pass the sheet 123, that is, the hair can be driven through the bristles 122, during the rotation, the sheet 123 will have certain supporting effect to the hair, thus, firstly, it is convenient for the movable blade 132 and the fixed blade 131 to cut the hair, and secondly, it is convenient to collect the hair into a dust box.

For the positions of providing the fixed blade and the movable blade, it is necessary to define providing them oblique to the rolling brush, moreover, during the rotation of the rolling brush, the movable blade is provided along the rotating direction of the rolling brush, that is, in the cross section of the rolling brush, at the intersection of the straight line of the extending direction of the movable blade and the cross section of the rolling brush, the included angle between the tangent line in the rotating direction of the rolling brush and the extending direction of the movable blade is an acute angle. In an embodiment, as shown in FIG. 1, the fixed blade and the movable blade are provided on the top right of the rolling brush, the rotating direction of the rolling brush in FIG. 1 is anticlockwise, the direction of the tangent line corresponding to the tail end of the movable blade faces the upper left, and an acute angle is formed between this direction and the extending direction of the movable blade, thus the size of the overlapping with the bristles in the radial direction can be reduced, the possibility can be effectively lowered that sundries directly strike the movable blade, and the service life of the movable blade is improved.

As shown in FIG. 1, the hair cutting assembly 100 provided in an embodiment according to the present disclosure comprises the housing 110, the rolling brush 120, the fixed blade 131 and the movable blade 132. And the rolling brush 120, the fixed blade 131 and the movable blade 132 are all connected to the housing 110, and the housing 110 mainly plays a role of a mounting carrier. In some embodiments, the rolling brush 120 can rotate with respect to the housing 110 along its rotating axis. In a further embodiment, the rolling brush 120 comprises the roller and multiple rows of bristles 122 provided at the circumferential side wall of the roller. The rotating axis of the rolling brush 120 can be understood as the rotating axis of the roller. The rotation of the rolling brush 120 is substantially that the roller brings the bristles 122 to rotate. When a cleaning device performs a cleaning operation, the rolling brush 120 contacts the ground, the bristles 122 of the rolling brush 120 beat the dust on the ground and brush the wastes up, and sweep the wastes into the housing 110.

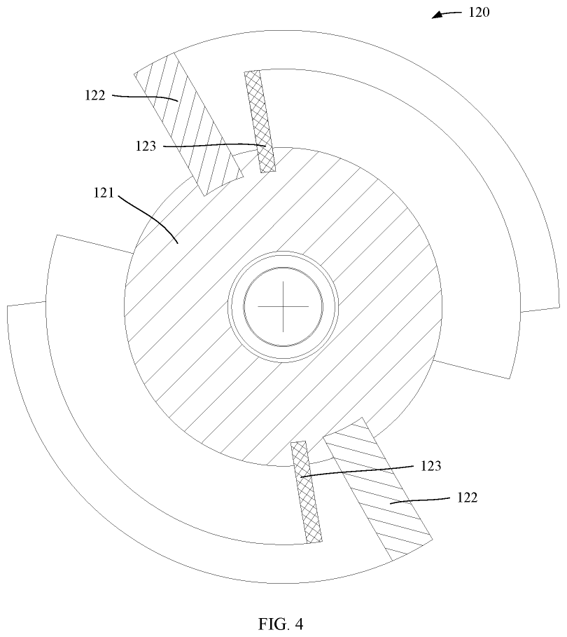

In some embodiments, as shown in FIG. 3, the fixed blade 131 is provided with a first cutter tooth 1312, the movable blade 132 is provided with a second cutter tooth 1322, the first cutter tooth 1312 and the second cutter tooth 1322 are respectively provided at the side of the fixed blade 131 and the movable blade 132 facing the rolling brush 120, for example, the fixed blade 131 is provided at the lower side of the first cutter tooth 1312, the movable blade 132 is provided at the lower side of the second cutter tooth 1322, and thus cutting the hair is achieved when the movable blade 132 is driven to do reciprocating motion with respect to the fixed blade 131. It needs to be emphasized that in this solution, the first cutter teeth 1312 and the second cutter teeth 1322 are arranged at an interval, and meanwhile each first cutter tooth 1312 is provided corresponding to one second cutter tooth 1322, during the reciprocating motion of the movable blade 132, the motion route of the second cutter tooth 1322 will be located between two corresponding first cutter teeth 1312, and cutting the hair is achieved by the shortest route.

In addition, as shown in FIG. 10, in this solution the positions of the first cutter tooth 1312 and the second cutter tooth 1322 are not arranged uniformly, while are arranged in an irregular staggered corresponding relation, that is, there is a distance difference H between the left side of the first cutter tooth 1312 and the left side of the second cutter tooth 1322, the distance different H can fluctuate between 0.1 mm and 2 mm, for the first cutter tooth 1312 and the second cutter tooth 1322, using a non-uniform distribution can improve the cutting effect to the hair.

It can be understood that the first cutter tooth 1312 and the second cutter tooth 1322 are all located at the outside of the first housing 110 and the second housing 110, and thus cutting the outside hair is achieved.

And the edge of the first cutter tooth 1312 on the fixed blade 131 can choose to be cut at one side or at two sides based on the position of the fixed blade 131.

In a specific embodiment, in the cross section of the rolling brush 120, the distance between the end of the first cutter tooth 1312 facing the rolling brush 120 and the rotating axis is a fourth distance, and when the movable blade 132 is at a first working position, the distance between the end of the second cutter tooth 1322 facing the rolling brush 120 and the rotating axis is a fifth distance, and when the movable blade 132 is at a second working position, the distance between the end of the second cutter tooth 1322 facing the rolling brush 120 and the rotating axis is a third distance, the fifth distance is greater than the fourth distance, and the third distance is greater than the fourth distance.

The fifth distance is greater than the fourth distance, that is, the distance between the tooth tip side of the movable blade 132 which is at the first working position and the rotating axis of the rolling brush 120 is greater than the distance between the tooth tip side of the fixed blade 131 and the rotating axis of the rolling brush 120. The third distance is greater than the fourth distance, that is, the distance between the tooth tip side of the movable blade 132 which is at the second working position and the rotating axis of the rolling brush 120 is greater than the distance between the tooth tip side of the fixed blade 131 and the rotating axis of the rolling brush 120. In sum, no matter the movable blade 132 is at the first working position or at the second working position, the distance between its tooth tip side and the rotating axis of the rolling brush 120 is always greater than the distance between the tooth tip side of the fixed blade 131 and the rotating axis. The wastes adhered to the rolling brush 120 or winding the rolling brush 120 first contact the fixed blade 131 that does not move, and this helps protect the movable blade 132, and lowers the damage of the wastes to the blade. The tooth tip side of the fixed blade 131 protrudes more (closer to the rolling brush 120) than the tooth tip side of the movable blade 132, and this prevents human body from directly touching the tip of the movable blade 132 and then prevents rendering injury.

In some embodiments, the fifth distance is greater than the third distance, and the difference between the third distance and the fourth distance is not less than 0.1 mm.

The fifth distance is greater than the third distance, that is, the distance between the tooth tip side of the movable blade 132 which is at the first working position and the rotating axis of the rolling brush 120 is greater than the distance between the tooth tip side of the movable blade 132 which is at the second working position and the rotating axis of the rolling brush 120. When the movable blade 132 moves from the first working position to the second working position, the movable blade 132 gets close to the rolling brush 120 gradually; when the movable blade 132 moves from the second working position to the first working position, the movable blade 132 gets away from the rolling brush 120 gradually. Through limiting that the difference between the third distance and the fourth distance is not less than 0.1 mm, firstly, it is ensured that the third distance is greater than the fourth distance, and then the wastes adhered to the rolling brush 120 or winding the rolling brush 120 first contact the fixed blade 131 that does not move, and then the movable blade 132 is protected; secondly, it is limited that the difference between the third distance and the fourth distance will not be too large, and then the cutting effect of the movable blade 132 to the fibrous wastes is ensured.

In some embodiments, the fourth distance is not greater than the maximum radius size of the rolling brush 120, and the difference between the fourth distance and the maximum radius size is not greater than 5 mm; the third distance is not less than the maximum radius size, and the difference between the third distance and the maximum radius size is not greater than 5 mm.

The maximum radius size of the rolling brush 120 is the distance between the outermost edge of the rolling brush 120 and the axis. In a further embodiment, the result rendered by subtracting the length of the bristles 122 that are embedded into the roller from the sum of the radius of the roller and the length of the bristles 122 equals the maximum radius size of the rolling brush 120. The fourth distance is not greater than the maximum radius size of the rolling brush 120, that is, the distance between the tooth tip side of the fixed blade 131 and the rotating axis of the rolling brush 120 is less than or equal to the maximum radius size of the rolling brush 120. When the distance between the tooth tip side of the fixed blade 131 and the rotating axis of the rolling brush 120 is less than the maximum radius size of the rolling brush 120, it shows that the tooth tip side of the fixed blade 131 can extend into the rolling brush 120, to improve the cutting effect of the fixed blade 131 to the wastes adhered to the rolling brush 120 or winding the rolling brush 120. In some embodiments, the difference between the fourth distance and the maximum radius size of the rolling brush 120 is not greater than 5 mm, and the extending length of the tooth tip side of the fixed blade 131 extending into the rolling brush 120 is less than or equal to 5 mm, firstly, this can ensure the cutting effect of the fixed blade 131 per se; secondly, this prevents a too large extending length of the tooth tip side of the fixed blade 131, and then prevents affecting the extension of the bristles 122 and increasing the rotating resistance to the rolling brush 120.

In some embodiments, the third distance is not less than the maximum radius size of the rolling brush 120, that is, the distance between the tooth tip side of the movable blade 132 which is at the second working position and the rotating axis of the rolling brush 120 is greater than or equal to the maximum radius size of the rolling brush 120. This has an understanding that the tooth tip side of the movable blade 132 does not extend into the rolling brush 120. In some embodiments, the difference between the third distance and the maximum radius size of the rolling brush 120 is not greater than 5 mm, although the tooth tip side of the movable blade 132 does not extend into the rolling brush 120, its tooth tip side is sufficiently close to the outermost edge of the rolling brush 120, to ensure the cutting effect of the movable blade 132.

And the fourth distance is not less than the maximum radius size of the rolling brush 120, and the difference between the fourth distance and the maximum radius size is not greater than 5 mm.

The fourth distance is not less than the maximum radius size of the rolling brush 120, that is, the distance between the tooth tip side of the fixed blade 131 and the rotating axis of the rolling brush 120 is greater than or equal to the maximum radius size of the rolling brush 120. This has an understanding that the tooth tip side of the fixed blade 131 does not extend into the rolling brush 120, to prevent the tooth tip side of the fixed blade 131 from affecting the extension of the bristles 122 and increasing the rotating resistance to the rolling brush 120 after the tooth tip side of the fixed blade 131 extends into the rolling brush 120. In some embodiments, the difference between the fourth distance and the maximum radius size of the rolling brush 120 is not greater than 5 mm, although the tooth tip side of the fixed blade 131 does not extend into the rolling brush 120, its tooth tip side is sufficiently close to the outermost edge of the rolling brush 120, to ensure the cutting effect of the fixed blade 131.

In another embodiment, the housing 110 comprises a cavity 114, at least a portion of the rolling brush 120 is provided in the cavity 114, at least a portion of the fixed blade 131 is provided in the cavity 114, and when the movable blade 132 is at the second working position, at least a portion of the movable blade 132 is provided in the cavity 114.

In this embodiment, at least a portion of the rolling brush 120 is provided in the cavity 114, at least a portion of the fixed blade 131 is provided in the cavity 114, and at least a portion of the movable blade 132 at the second working position is provided in the cavity 114. When a cleaning device performs a cleaning operation, the rolling brush 120 contacts the ground, the bristles 122 of the rolling brush 120 beat the dust on the ground and brush the wastes up, and sweep the wastes into the cavity 114 of the housing 110; when the wastes rotate with the rolling brush 120 along the rotating direction of the rolling brush, the relative motion of the movable blade 132 and the fixed blade 131 forms an effective cutting action, the fibrous wastes (for example, the hair winding the rolling brush 120) are cut, and then this portion of wastes is absorbed and collected into a storage container or a storage cavity.

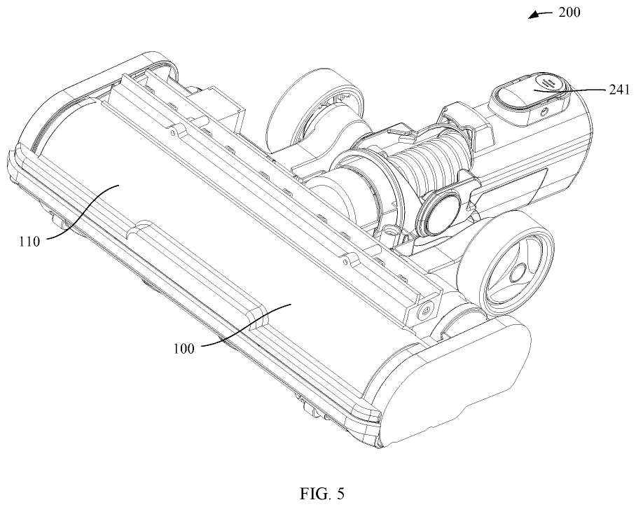

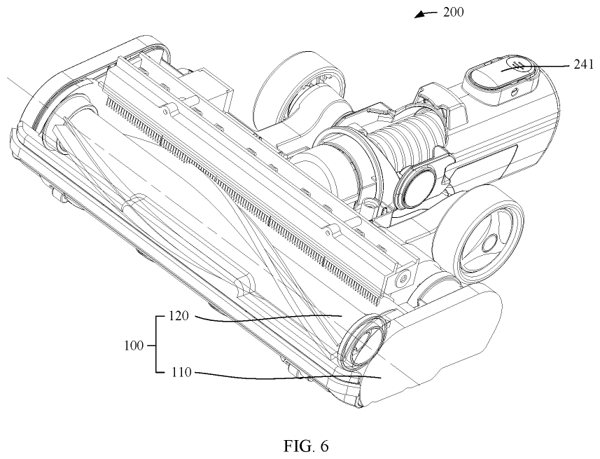

As shown in FIG. 5 and FIG. 6, a cleaning device 200 provided by an embodiment of the present disclosure comprises the hair cutting assembly 100 in any of the above embodiments, a first driving member 211 and a second driving member 212. In an embodiment, the first driving member 211 is connected to the rolling brush 120 of the hair cutting assembly 100, and the first driving member 211 is configured to drive the rolling brush 120 to rotate along its axis. The first driving member 211 drives the rolling brush 120 to rotate along a first rotating direction or a second rotating direction. In a further embodiment, the rotation of the rolling brush 120 along the first rotating direction is the forward rotation of the rolling brush 120; and the rotation of the rolling brush 120 along the second rotating direction is the reverse rotation of the rolling brush 120. When the cleaning device 200 performs a cleaning operation, the rolling brush 120 contacts the ground, the bristles 122 of the rolling brush 120 beat the dust on the ground and brush the wastes up, and sweep the wastes into the cavity 114 of the housing 110.

In some embodiments, the second driving member 212 is connected to the movable blade 132 of the hair cutting assembly 100, and the second driving member 212 is configured to drive the movable blade 132 to move with respect to the fixed blade 131 of the hair cutting assembly 100. The relative motion of the movable blade 132 and the fixed blade 131 forms an effective cutting action, and then the fibrous wastes (for example, the hair winding the rolling brush 120) are cut, to improve the cleaning effect.

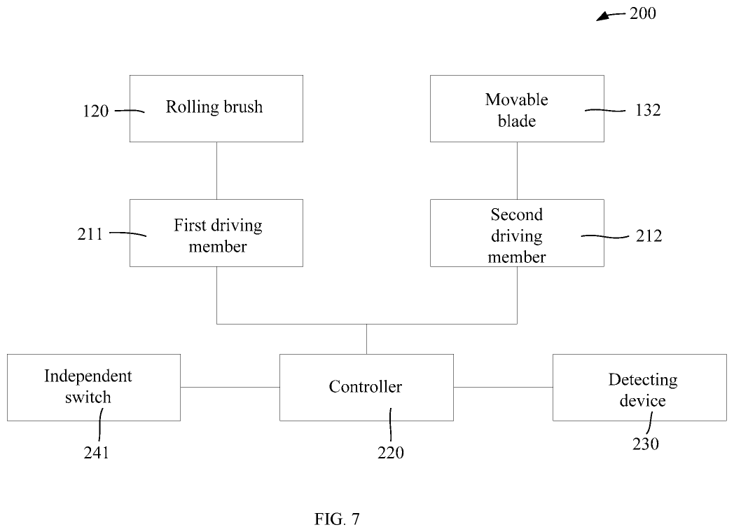

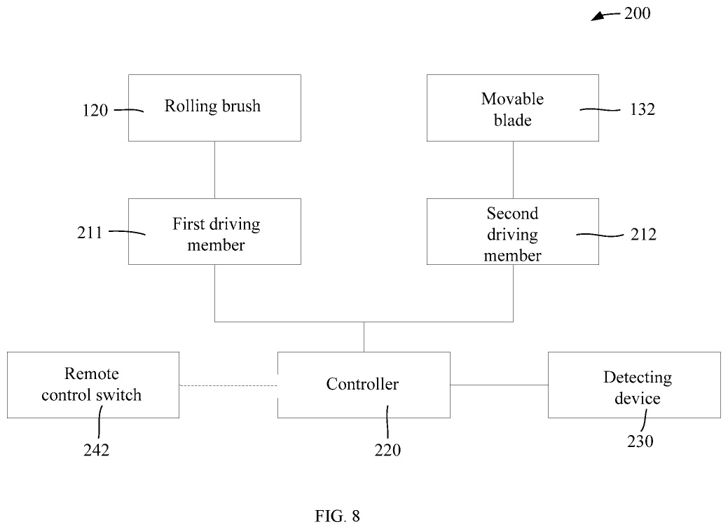

In some embodiments, as shown in FIG. 7 and FIG. 8, a controller 220 is connected to the first driving member 211, and the controller 220 is connected to the second driving member 212. For the controller 220, its control method is as follows: determining that the rolling brush 120 is in a working state, and limiting the movable blade 132 to be always in a moving state; or determining that the rolling brush 120 is in a working state, and limiting the movable blade 132 to move intermittently; or determining that the rolling brush 120 is in a working state, limiting the movable blade 132 to be in a moving state, and limiting the movable blade 132 to stop moving after a time threshold; or determining that the rolling brush 120 is not in a working state, and limiting the movable blade 132 to be in a moving state; or limiting the movable blade 132 to be in a moving state, and limiting the rolling brush 120 to rotate reversely.

In some embodiments, as shown in FIG. 7 and FIG. 8, the cleaning device 200 further comprises a detecting device 230. In an embodiment, the detecting device 230 is connected to the controller 220. The detecting device 230 is configured to detect the amount of the wastes that are adhered to or wind the rolling brush 120. The controller 220 can control the motion state of the movable blade 132 based on the information of the amount of the wastes provided by the detecting device 230. The specific control method is as follows: determining that the rolling brush 120 is in a working state, and limiting the movable blade 132 to be in a moving state when the detecting device 230 determines that the amount of the wastes on the rolling brush 120 is greater than a first threshold; or limiting the movable blade 132 to be in a moving state, and limiting the movable blade 132 to stop moving when the detecting device 230 determines that the amount of the wastes on the rolling brush 120 is less than a second threshold. The second threshold is not greater than the first threshold. This has an understanding that the first threshold can be the same with the second threshold, and can further be different from the second threshold. When the first threshold is different from the second threshold, the second threshold is less than the first threshold.

In some embodiments, the detecting device 230 is connected to the housing 110 of the hair cutting assembly 100, and the detecting device 230 is an optical recognition camera; or the detecting device 230 is connected to the first driving member 211 and is configured to detect the current value of the first driving member 211. The detecting device 230 has two solutions, and the first solution is the optical recognition camera, and the amount of the wastes that are adhered to or wind the rolling brush 120 is determined directly through the optical recognition camera; and the second solution is an electronic device, which is configured to detect the current value of the first driving member 211, when the current value is larger than a threshold, it means that the amount of the wastes that are adhered to or wind the rolling brush 120 is relatively large; when the current value is not larger than the threshold, it means that the amount of the wastes that are adhered to or wind the rolling brush 120 is relatively small.

It needs to be explained that the cleaning device 200 comprises, while is not limited to, a vacuum cleaner, a floor scrubber, a sweeping robot and the like that can collect and clean the dust and hair on the floor.

In another embodiment, as shown in FIG. 7, the cleaning device 200 further comprises an independent switch 241, and the independent switch 241 is connected to the controller 220. The controller 220 can limit whether the movable blade 132 is in the moving state based on the switch information of the independent switch 241.

In another embodiment, as shown in FIG. 8, the cleaning device 200 further comprises a remote control switch 242, and the remote control switch 242 is connected to the controller 220. The controller 220 can limit whether the movable blade 132 is in the moving state based on the switch information of the remote control switch 242.

And the above two embodiments differ in that the independent switch 241 is an independent switch entity structure, and the remote control switch 242 is a function button integrated into a virtual screen, or a written program.

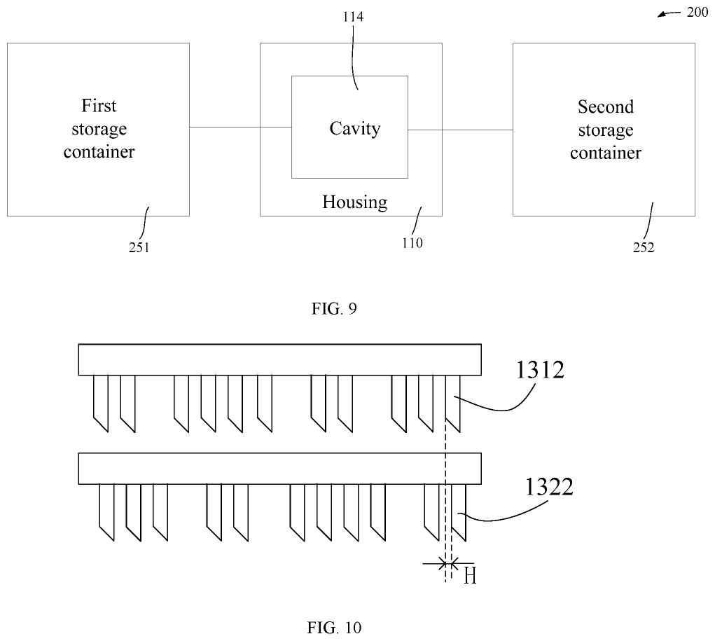

In another embodiment, as shown in FIG. 9, the cleaning device 200 further comprises a first storage container 251 and a second storage container 252. In an embodiment, the first storage container 251 is connected to the housing 110 of the hair cutting assembly 100. The first storage container 251 is configured to store a cleaning liquid. The first storage container 251 communicates with the cavity 114 of the hair cutting assembly 100. In some embodiments, the second storage container 252 is connected to the housing 110. The second storage container 252 is configured to store wastes and sewage. The second storage container 252 communicates with the cavity 114 of the hair cutting assembly 100. The cleaning liquid stored in the first storage container 251 can be coated on the surface of the rolling brush 120, to improve the cleaning effect. The wastes rolled up by the rolling brush 120, the wastes after cutting and processed sewage all flow to the second storage container 252, and the user can pour out the wastes and the sewage stored in the second storage container 252 after the cleaning work is accomplished.

In one embodiment, an independent switch/a remote control switch can be directly provided on the cleaning device 200, the user determines whether the movable blade 132 moves with respect to the fixed blade 131 through the operation of the switch, then feeds back to the controller 220, and finally limits the motion of the movable blade 132 based on the instructions of the switch.

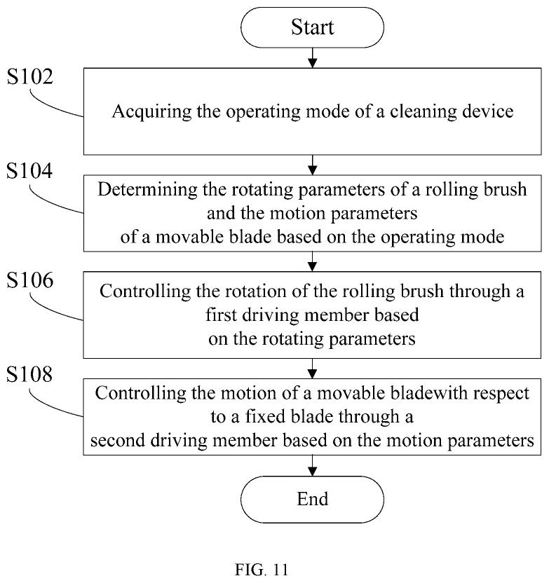

One embodiment of the present disclosure provides a cutting control method which is used for the control device of the cleaning device in the above embodiment, as shown in FIG. 11, the cutting control method comprises:
step S102: acquiring the operating mode of the cleaning device;
step S104: determining the rotating parameters of the rolling brush and the motion parameters of the movable blade based on the operating mode;
step S106: controlling the rotation of the rolling brush through the first driving member based on the rotating parameters; and
step S108: controlling the motion of the movable blade with respect to the fixed blade through the second driving member based on the motion parameters.

In the embodiment, the operating mode is first acquired, corresponding rotating parameters and motion parameters can be determined based on different operating modes, which comprise, while are not limited to, a rotating speed, a rotating direction, a rotating frequency, a moving distance, a moving speed, etc. Then the motion of the rolling brush and the movable blade are controlled respectively based on the rotating parameters and the motion parameters, and thus operations in different modes can be achieved.

In some embodiments, the detecting device can be additionally provided to detect the wastes on the rolling brush, i.e., the detecting device detects the amount of the wastes that are adhered to or wind the rolling brush. Thus, the motion state of the movable blade can be controlled based on the information of the amount of the wastes provided by the detecting device. The specific control method is as follows: determining that the rolling brush is in a working state, and limiting the movable blade to be in a moving state when the detecting device determines that the amount of the wastes on the rolling brush is greater than a first threshold; or limiting the movable blade to be in a moving state, and limiting the movable blade to stop moving when the detecting device determines that the amount of the wastes on the rolling brush is less than a second threshold. The second threshold is not greater than the first threshold. This has an understanding that the first threshold can be the same with the second threshold, and can further be different from the second threshold. When the first threshold is different from the second threshold, the second threshold is less than the first threshold.

In one specific embodiment, it is determined that the rolling brush of the cleaning device is in a working state, and the movable blade of the cleaning device is limited to be always in a moving state; or it is determined that the rolling brush of the cleaning device is in a working state, and the movable blade of the cleaning device is limited to move intermittently; or it is determined that the rolling brush of the cleaning device is in a working state, and the movable blade of the cleaning device is limited to be in a moving state, and the movable blade is limited to stop moving after a time threshold; or it is determined that the rolling brush of the cleaning device is not in a working state, and the movable blade of the cleaning device is limited to be in a moving state; or when the movable blade of the cleaning device is limited to be in a moving state, the rolling brush of the cleaning device is limited to rotate inversely; or based on the independent switch of the cleaning device, whether the movable blade of the cleaning device is in a moving state is limited; or based on the remote control switch of the cleaning device, whether the movable blade of the cleaning device is in a moving state is limited; or based on the detecting device of the cleaning device, the motion state of the movable blade of the cleaning device is limited.

In another embodiment, based on the detecting device of the cleaning device, limiting the motion state of the movable blade of the cleaning device is in an embodiment as follows:
determining that the rolling brush of the cleaning device is in a working state, and limiting the movable blade to be in a moving state when the detecting device determines that the amount of the wastes on the rolling brush is greater than a first threshold; or limiting the movable blade to be in a moving state, and limiting the movable blade to stop moving when the detecting device determines that the amount of the wastes on the rolling brush is less than a second threshold. The second threshold is not greater than the first threshold. This has an understanding that the first threshold can be the same with the second threshold, and can further be different from the second threshold. When the first threshold is different from the second threshold, the second threshold is less than the first threshold.

As shown in FIG. 1, the hair cutting assembly 100 provided in one embodiment of the present disclosure comprises the housing 110, the rolling brush 120, the fixed blade 131 and the movable blade 132. And the rolling brush 120, the fixed blade 131 and the movable blade 132 are all connected to the housing 110, and the housing 110 mainly plays a role of a mounting carrier. In some embodiments, the rolling brush 120 can rotate with respect to the housing 110 along the rotating axis. In a further embodiment, as shown in FIG. 1, FIG. 2 and FIG. 3, the rolling brush 120 comprises the roller 121 and multiple rows of bristles 122 provided at the circumferential side wall of the roller 121. The rotating axis of the rolling brush 120 can be understood as the rotating axis of the roller 121. The rotation of the rolling brush 120 is substantially that the roller 121 brings the bristles 122 to rotate. When the cleaning device 200 performs a cleaning operation, the rolling brush 120 contacts the ground, the bristles 122 of the rolling brush 120 beat the dust on the ground and brush the wastes up, and sweep the wastes into the housing 110.

In some embodiments, the fixed blade 131 is fixed with respect to the housing 110. The movable blade 132 can move with respect to the fixed blade 131. In a further embodiment, the movable blade 132 abuts on the fixed blade 131. In a further embodiment, the movable blade 132 comprises a first working position and a second working position. The movable blade 132 can move from the first working position to the second working position or from the second working position to the first working position. In a further embodiment, the movable blade 132 moves and cuts along the rotating axis of the rolling brush 120. The movable blade 132 moves between the first working position and the second working position with respect to the fixed blade 131, the relative motion of the movable blade 132 and the fixed blade 131 forms an effective cutting action, and then the fibrous wastes (for example, the hair winding the rolling brush 120) are cut. In a further embodiment, the housing 110 comprises a mounting housing 111, a first support housing 112 and a second support housing 113. The rolling brush 120 is connected to the mounting housing 111, and can rotate with respect to the mounting housing 111 along the rotating axis. The fixed blade 131 is connected to the first support housing 112, and the movable blade 132 is connected to the second support housing 113. The first support housing 112 is connected to the mounting housing 111, and the second support housing 113 is connected to the mounting housing 111. The connecting method between the first support housing 112 and the mounting housing 111 is bonding, welding, etc.; and the connecting method between the second support housing 113 and the mounting housing 111 is bonding, welding, etc.

In some embodiments, the fixed blade 131 is adjacent to the movable blade 132 with respect to the circumferential direction of the rolling brush 120. In a further embodiment, the fixed blade 131 and the movable blade 132 are located at the same side of a plane. When the plane where the rotating axis of the rolling brush 120 is located rotates with the rolling brush 120 along a first rotating direction, the plane passes the fixed blade 131 and the movable blade 132 successively. When the wastes rotate with the rolling brush 120 along its rotating direction, the fixed blade 131 that does not move is first contacted, and the movable blade 132 can be protected in a certain extent, the damage to the movable blade from the wastes is lowered, the effective use period of the movable blade is ensured, and this helps improve the cutting effect of the movable blade to the fibrous wastes.

At least one fixed blade 131 is provided at the side of the movable blade 132 along the circumferential direction of the rolling brush 120, and at least one fixed blade 131 is provided at the other side of the movable blade 132 along the circumferential direction of the rolling brush 120. In the process of rotating with the rolling brush 120 along the second rotating direction, before passing the movable blade 132, the plane where the rotating axis of the rolling brush 120 is located passes at least one fixed blade 131. The second rotating direction is opposite to the first rotating direction. At least one fixed blade 131 is provided at each of the two sides of the movable blade 132 along the circumferential direction of the rolling brush 120. In a further embodiment, the first rotating direction is a forward rotation, and the second rotating direction is a reverse rotation. No matter the rolling brush 120 rotates in a forward rotation or in a reverse rotation, when the plane where the rotating axis of the rolling brush 120 is located rotates together with the rolling brush 120, the plane always passes at least one fixed blade 131 and the movable blade 132 successively, to ensure that the wastes rotating with the rolling brush 120 first contact the fixed blade 131 that does not move, and this helps protect the movable blade 132, and lowers the damage of the wastes to the movable blade. Considering the cutting effect of the fixed blade 131 and the movable blade 132 to the fibrous wastes, the size of the occupied space, the protection degree to the movable blade 132, the costs and other factors, the number of the fixed blade 131 and the number of the movable blade 132 are disposed flexibly based on actual needs.

As shown in FIG. 1, the tooth tip side of the fixed blade 131 is disposed facing the rolling brush 120, and the tooth tip side of the movable blade 132 is disposed facing the rolling brush 120. Through disposing the tooth tip sides of the blades facing the rolling brush 120, a portion of the wastes adhered to the rolling brush 120 or winding the rolling brush 120 can be cut by the cutting edge of the blade at the tooth tip side, to remove the winding and absorb the waste, and this helps improve the cleaning effect of the cleaning device 200.

In some embodiments, the movable blade 132 comprises the first working position and the second working position. The movable blade 132 can move from the first working position to the second working position or from the second working position to the first working position. In a further embodiment, the movable blade 132 moves and cuts along the rotating axis of the rolling brush 120. The movable blade 132 moves between the first working position and the second working position with respect to the fixed blade 131, the relative motion of the movable blade 132 and the fixed blade 131 forms an effective cutting action, and then the fibrous wastes (for example, the hair winding the rolling brush 120) are cut, and this helps improve the cutting effect of the blades, and further enhance the cleaning effect of the cleaning device 200.

In some embodiments, the distance between the tooth tip side of the fixed blade 131 and the rotating axis of the rolling brush 120 is a first distance. The distance between the tooth tip side of the movable blade 132 which is located at the first working position and the rotating axis of the rolling brush 120 is a second distance. The distance between the tooth tip side of the movable blade 132 which is located at the second working position and the rotating axis of the rolling brush 120 is a third distance. The second distance is greater than the first distance, i.e., the distance between the tooth tip side of the movable blade 132 which is located at the first working position and the rotating axis of the rolling brush 120 is greater than the distance between the tooth tip side of the fixed blade 131 and the rotating axis of the rolling brush 120. The third distance is greater than the first distance, i.e., the distance between the tooth tip side of the movable blade 132 which is located at the second working position and the rotating axis of the rolling brush 120 is greater than the distance between the tooth tip side of the fixed blade 131 and the rotating axis of the rolling brush 120. In a word, no matter the movable blade 132 is located at the first working position or the second working position, the distance between the tooth tip side of the movable blade 132 and the rotating axis of the rolling brush 120 is always greater than the distance between the tooth tip side of the fixed blade 131 and the rotating axis. The wastes adhered to the rolling brush 120 or winding the rolling brush 120 first contact the fixed blade 131 that does not move, and this helps protect the movable blade 132, and lowers the damage of the wastes to the blade. The tooth tip side of the fixed blade 131 protrudes more (closer to the rolling brush 120) than the tooth tip side of the movable blade 132, and this prevents human body from directly touching the tip of the movable blade 132 and then prevents rendering injury.

In some embodiments, the second distance is greater than the third distance, i.e., the distance between the tooth tip side of the movable blade 132 which is located at the first working position and the rotating axis of the rolling brush 120 is greater than the distance between the tooth tip side of the movable blade 132 which is located at the second working position and the rotating axis of the rolling brush 120. When the movable blade 132 moves from the first working position towards the second working position, the movable blade 132 gets close to the rolling brush 120 gradually; when the movable blade 132 moves from the second working position to the first working position, the movable blade 132 gets away from the rolling brush 120 gradually. Through limiting that the difference between the third distance and the first distance is not less than 0.1 mm, firstly, it is ensured that the third distance is greater than the first distance, and then the wastes adhered to the rolling brush 120 or winding the rolling brush 120 first contact the fixed blade 131 that does not move, and then the movable blade 132 is protected; secondly, it is limited that the difference between the third distance and the first distance will not be too large, and then the cutting effect of the movable blade 132 to the fibrous wastes is ensured.

In some embodiments, the maximum radial size of the rolling brush 120 is the distance between the outermost edge and the rotating axis of the rolling brush 120. In a further embodiment, the result rendered by subtracting the length of the bristles 122 embedded into the roller 121 from the sum of the radius of the roller 121 and the length of the bristles 122 equals the maximum radial size of the rolling brush 120. The first distance is not greater than the maximum radial size of the rolling brush 120, i.e., the distance between the tooth tip side of the fixed blade 131 and the rotating axis of the rolling brush 120 is less than or equal to the maximum radial size of the rolling brush 120. When the distance between the tooth tip side of the fixed blade 131 and the rotating axis of the rolling brush 120 is less than the maximum radial size of the rolling brush 120, it means that the tooth tip side of the fixed blade 131 can extend into the rolling brush 120, to improve the cutting effect of the fixed blade 131 to the wastes adhered to the rolling brush 120 or winding the rolling brush 120. In some embodiments, the difference between the first distance and the maximum radial size of the rolling brush 120 is not greater than 5 mm, the difference rendered by subtracting the first distance from the maximum radial size of the rolling brush 120 is less than or equal to 5 mm, and the extending length of the tooth tip side of the fixed blade 131 extending into the rolling brush 120 is less than or equal to 5 mm, firstly, this can ensure the cutting effect of the fixed blade 131 per se; and secondly, this prevents a too large extending length of the tooth tip side of the fixed blade 131, and then prevents affecting the extension of the bristles 122 and increasing the rotating resistance to the rolling brush 120.

In some embodiments, the third distance is not less than the maximum radial size of the rolling brush 120, i.e., the distance between the tooth tip side of the movable blade 132 which is located at the second working position and the rotating axis of the rolling brush 120 is greater than or equal to maximum radial size of the rolling brush 120. This has an understanding that the tooth tip side of the movable blade 132 does not extend into the rolling brush 120. In some embodiments, the difference between the third distance and the maximum radial size of the rolling brush 120 is not greater than 5 mm, the difference rendered by subtracting the maximum radial size of the rolling brush 120 from the third distance is less than or equal to 5 mm; although the tooth tip side of the movable blade 132 does not extend into the rolling brush 120, the tooth tip side of the movable blade 132 is close enough to the outermost edge of the rolling brush 120, to ensure the cutting effect of the movable blade 132.

In another embodiment, the first distance is not less than the maximum radial size of the rolling brush 120, i.e., the distance between the tooth tip side of the fixed blade 131 and the rotating axis of the rolling brush 120 is greater than or equal to maximum radial size of the rolling brush 120. This has an understanding that the tooth tip side of the fixed blade 131 does not extend into the rolling brush 120, and this prevents affecting the extension of the bristles 122 and increasing the rotating resistance to the rolling brush 120 after the tooth tip side of the fixed blade 131 extends into the rolling brush 120. In some embodiments, the difference between the first distance and the maximum radial size of the rolling brush 120 is not greater than 5 mm, the difference rendered by subtracting the maximum radial size of the rolling brush 120 from the first distance is less than or equal to 5 mm; although the tooth tip side of the fixed blade 131 does not extend into the rolling brush 120, the tooth tip side of the fixed blade 131 is close enough to the outermost edge of the rolling brush 120, to ensure the cutting effect of the fixed blade 131.

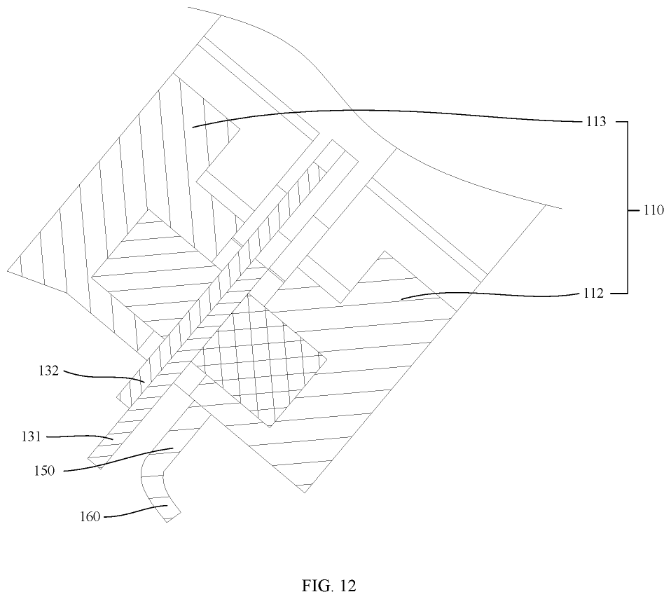

As shown in FIG. 12, the hair cutting assembly 100 further comprises a shielding portion 150. In an embodiment, the shielding portion 150 is connected to the housing 110. The shielding portion 150 is provided at the side of the fixed blade 131 away from the movable blade 132. Through disposing the shielding portion 150, firstly, it has the function of shielding dust, and secondly, it can protect the fixed blade 131 or the movable blade 132 in a certain extent. In a further embodiment, the shielding portion 150 is connected to the mounting housing 111 of the housing 110. The connecting method between the shielding portion 150 and the mounting housing 111 is bonding, welding, etc.

In some embodiment, the hair cutting assembly 100 further comprises a guiding portion 160. In an embodiment, the guiding portion 160 is connected to the shielding portion 150. The guiding portion 160 extends towards a direction away from the fixed blade 131. Through providing the guiding portion 160 to guide the dusts or wastes, this prevents the blades from contacting the non-fibrous wastes in a great extent, protects the blades, and reduces the damage to the blade assembly by the wastes. In a further embodiment, the guiding portion 160 and the shielding portion 150 are an integrated structure, and compared with the way of post-possessing, the integrated structure has a good mechanical property and a high connection strength, and this helps reduce the number of the parts and components and improve assembling efficiency.

In another embodiment, the number of the rolling brush 120 is at least one, i.e., there can be one rolling brush 120, or two or multiple rolling brushes 120, and out of the consideration of the cleaning effect, the size of the occupied space, the costs and other factors, the number of the rolling brush 120 is disposed flexibly based on actual needs. In some embodiments, the fixed blade 131 and the movable blade 132 form a blade assembly. The number of the blade assembly is at least one, i.e., there can be one blade assembly, or two or multiple blade assemblies, and out of the consideration of the cleaning effect, the size of the occupied space, the costs and other factors, the number of the blade assembly is disposed flexibly based on actual needs. In some embodiments, the number of the rolling brush 120 is not less than the number of the blade assembly. In a further embodiment, the number of the rolling brushes 120 is two, and each rolling brush 120 is configured with one corresponding blade assembly; or, only one of the two rolling brushes 120 is configured with a blade assembly.

In another embodiment, as shown in FIG. 1, the housing 110 comprises a cavity 114, at least a portion of the rolling brush 120 is provided in the cavity 114, at least a portion of the fixed blade 131 is provided in the cavity 114, and at least a portion of the movable blade 132 when it is at the second working position is provided in the cavity 114. At least a portion of the rolling brush 120 is provided in the cavity 114, at least a portion of the fixed blade 131 is provided in the cavity 114, and at least a portion of the movable blade 132 when it is at the second working position is provided in the cavity 114. When the cleaning device 200 performs a cleaning operation, the rolling brush 120 contacts the ground, the bristles 122 of the rolling brush 120 beat the dust on the ground and brush the wastes up, and sweep the wastes into the cavity 114 of the housing 110; when the wastes rotate with the rolling brush 120 along the rotating direction of the rolling brush, the relative motion of the movable blade 132 and the fixed blade 131 forms an effective cutting action, the fibrous wastes (for example, the hair winding the rolling brush 120) are cut, and then this portion of wastes is absorbed and collected into a storage container or a storage cavity.

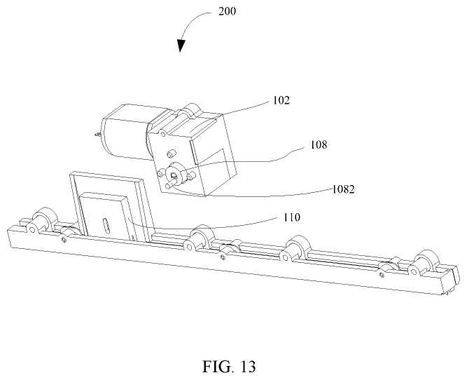

As shown in FIG. 13, the hair cutting assembly 100 provided in an embodiment according to the present disclosure mainly comprises a driving member 102, the movable blade 132 and the fixed blade 131; the driving member 102 plays a role of providing an active force, and will drive the movable blade 132 to do reciprocating motion under the effect of the eccentric column 1082, and in an embodiment, the movable blade 132 can move with respect to the fixed blade, and thus cutting the hair is achieved. In an embodiment, the movable blade 132 is in transmission connection with the driving member 102, and the driving member will bring the eccentric column provided at one side to rotate; since the eccentric column 1082 is provided at one side of the eccentric wheel 108, the movable blade 132 is provided with a first limiting hole 1324, through extending the eccentric column 1082 into the first limiting hole 1324, the movable blade 132 can be made to move along a second direction during the rotating. It needs to be emphasized that a cushion block 109 is provided at the side of the movable blade 132 away from the fixed blade 131, as shown in FIG. 15, through providing a driven part 1092 on the cushion block 109, when the eccentric column 1082 brings the movable blade 132 to move, it will further bring the cushion block 109 to move under the effect of the driven part 1092; it can be understood that the cushion block 109 moves together with the movable blade 132, providing the cushion block 109 on the movable blade 132 can increase the contact area between the eccentric column and the movable blade 132, therefore the torque acting on the movable blade 132 is reduced, that is, the force totally acts on the movable blade 132, and the thicker the movable blade 132 is, the higher the transmission efficiency of the force is and the smaller the abrasion is, however, what follows is the increase of the thickness of the single movable blade 132, and this does not help processing, while the present disclosure connects the cushion block 109 with the movable blade 132 through providing the cushion block 109 on the movable blade 132, uses the cushion block 109 to increase the contact area between the movable blade 132 and the eccentric column 1082 in a changed way, and then the lowering of abrasion is achieved.

In some embodiments, it needs to be emphasized that the eccentric column extends into the driven part, and the movable blade moves along the second direction, and the present disclosure does not define whether the movable blade 132 is provided with the first limiting hole 1324.

It can be understood that if the movable blade 132 is not provided with the first limiting hole 1324, the eccentric column 1082 can directly extend into the driven part, and this can further achieve the effect of lowering abrasion as mentioned in the embodiment.

It can be understood that a separated cushion block 109 is used, a relatively light wear-resistant material can be selected as the material of the cushion block 109, thus, compared with a solution of conducting thickening treatment to the blade directly, the mass is lowered in a certain extent, and the wear resistance is enhanced at the same time, and product competitiveness is improved greatly.

In addition, if abrasion occurs, as the cushion block 109 is provided at the side of the movable blade 132 away from the fixed blade 131, the cushion block 109 is located at the end portion of the movable blade 132, it will first have abrasion, and can be replaced separately at this time, and then the maintenance cost is lowered.

And the movable blade 132 extends along the second direction, the first limiting hole 1324 extends along a first direction perpendicular to the second direction, for example, the movable blade 132 moves laterally, the first limiting hole 1324 is arranged vertically, and the eccentric column 1082 will cooperate with the first limiting hole 1324 when the eccentric column 108 rotates, and then the movable blade 132 is made to move along the second direction.

It can be understood that the position of the fixed blade 131 is fixed, the movable blade 132 is in indirect connection with the driving member 102 through the eccentric column 1082, under the joint effect of the eccentric column 1082 and the first limiting hole 1324, the movable blade 132 can be made to move with respect to the fixed blade 131, and thus the cutting effect to the hair is achieved.

And the first limiting hole 1324 can be in a pore shape, or an elongate pore shape.

It needs to be added that the fixed blade 131 and the movable blade 132 are provided adjacent to each other, to achieve the cutting under the effect of an edge portion when the movable blade 132 moves.

In some embodiments, the driving member 102 can select a common electric motor or a gear motor.

In a specific embodiment, an eccentric wheel 108 is additionally provided, the eccentric wheel 108 is provided with the eccentric column 1082, and the eccentric wheel 108 can be directly sleeved on the driving shaft of the driving member 102.

As shown in FIG. 13, the hair cutting assembly provided in an embodiment according to the present disclosure mainly comprises the driving member 102, the eccentric wheel 108, the movable blade 132 and the fixed blade 131; the driving member 102 plays a role of providing an active force, and will drive the movable blade 132 to do reciprocating motion with respect to the fixed blade 131 under the effect of the eccentric column 108, to achieve cutting the hair. In an embodiment, the eccentric wheel 108 is in transmission connection with the driving member 102, and the driving member 102 will bring the eccentric column 108 to rotate; since the eccentric column 1082 is provided at one side of the eccentric wheel 108, the movable blade 132 is provided with the first limiting hole 1324, through extending the eccentric column 1082 into the first limiting hole 1324, the movable blade 132 can be made to move along the second direction during the rotating. And the movable blade 132 extends along the second direction, and the first limiting hole 1324 extends along a first direction perpendicular to the second direction, for example, the movable blade 132 moves laterally, the first limiting hole 1324 is arranged vertically, and the eccentric column 1082 will cooperate with the first limiting hole 1324 when the eccentric wheel 108 rotates, and then the movable blade 132 is made to move along the second direction. It needs to be emphasized that the cushion block 109 is provided at the side of the movable blade 132 away from the fixed blade 131, through providing the driven part 1092 on the cushion block 109, when the eccentric column 1082 brings the movable blade 132 to move, it will further bring the cushion block 109 to move under the effect of the driven part 1092; it can be understood that the cushion block 109 moves together with the movable blade 132, providing the cushion block 109 on the movable blade 132 can increase the contact area between the eccentric column and the movable blade 132, therefore the torque acting on the movable blade 132 is reduced, that is, the force totally acts on the movable blade 132, and the thicker the movable blade 132 is, the higher the transmission efficiency of the force is and the smaller the abrasion is, however, what follows is the increase of the thickness of the single movable blade 132, and this does not help processing, while the present disclosure connects the cushion block 109 with the movable blade 132 through providing the cushion block 109 on the movable blade 132, uses the cushion block 109 to increase the contact area between the movable blade 132 and the eccentric column 1082 in a changed way, and then the lowering of abrasion is achieved.

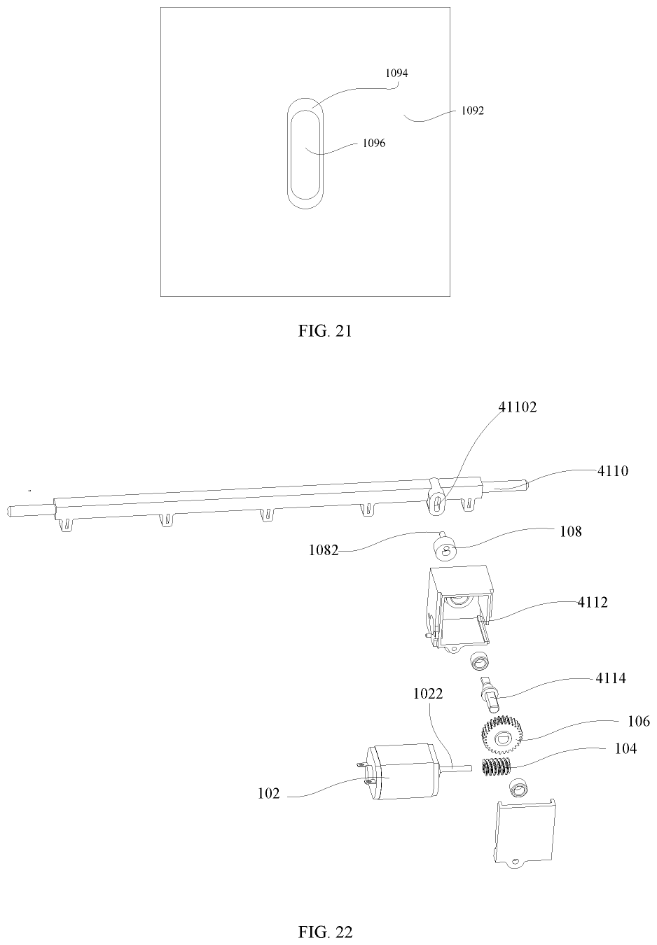

In a specific embodiment, as shown in FIG. 21, a protruding portion 1094 is provided on the driven part 1092, and the protruding portion 1094 is provided with a second limiting hole 1096 therein; when the cushion block 109 is connected to the movable blade 132, the protruding portion 1094 can be directly extended into the first limiting hole 1324, i.e., the cushion block 109 has a protection function not only at the outer side of the movable blade 132, but further in the first limiting hole 1324 directly; and the protruding portion 1094 is equivalent to the hole sleeve of the first limiting hole 1324, the eccentric column 1082 passes through the second limiting hole 1096 in the protruding portion 1094; when the eccentric column 1082 rotates, it will directly act on the protruding portion 1094 on the driven part 1092, i.e., the structure that directly contacts the eccentric column 1082 is the cushion block 109, and this greatly improves the wear protection effect of the movable blade 132.

In another specific embodiment, the cushion block 109 and the movable blade 132 are in an inserted connection relation, i.e., the movable blade 132 is hidden within the cushion block 109, and the cushion block 109 has a protection function for the movable blade 132 at the outer side; in the present solution, as shown in FIG. 20, a third limiting hole 1098 is provided in the driven part 1092, and after the assembling of the movable blade 132 and the cushion block 109 is accomplished, the third limiting hole 1098 and the first limiting hole 1324 are in a corresponding position relationship; the eccentric column 1082 will sequentially directly pass through the third limiting hole 1098 at one side of the cushion block 109, the first limiting hole 1324 and the third limiting hole 1098 at the other side, to accomplish the assembling.

In another specific embodiment, the driven part is provided with a fourth limiting hole 214, and the eccentric column is located in the fourth limiting hole 214. Using the fourth limiting hole 214 and the driven part can achieve driving the cushion block and the movable blade by the driving member.

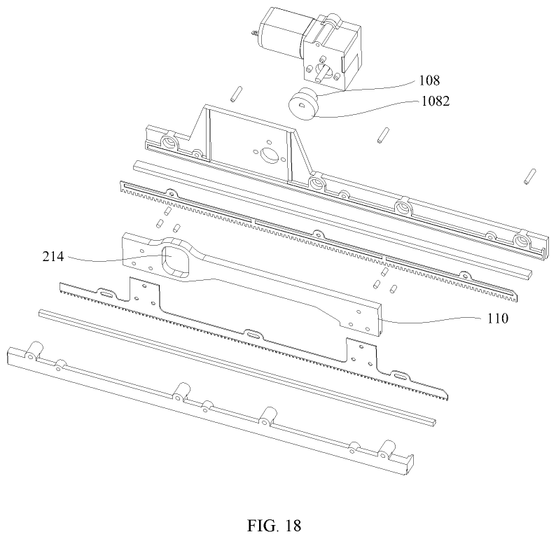

In one embodiment, as shown in FIG. 18, the size of the eccentric column is greater than the size of the eccentric wheel.

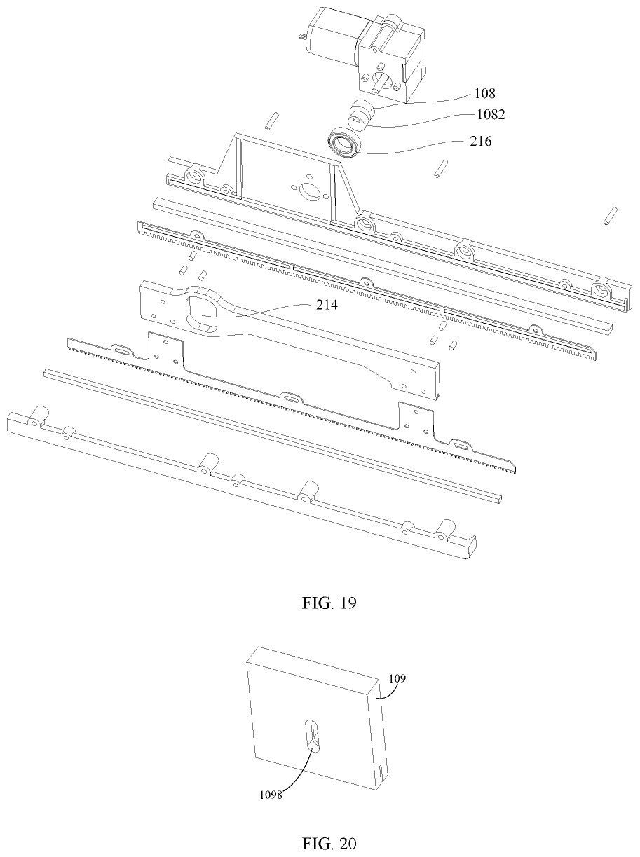

In another embodiment, as shown in FIG. 19, the size of the eccentric column is smaller than the size of the eccentric wheel, a bearing 216 is provided outside the eccentric column, the bearing 216 cooperates with the fourth limiting hole 214, to change the friction between the eccentric wheel and the contact portion of the cushion block from a sliding friction to a rolling friction, and this helps reducing the abrasion and noise.

As shown in FIG. 13, the hair cutting assembly provided in an embodiment according to the present disclosure mainly comprises the driving member 102, the eccentric wheel 108, the movable blade 132 and the fixed blade 131; the driving member 102 plays a role of providing an active force, and will drive the movable blade 132 to do reciprocating motion with respect to the fixed blade 131 under the effect of the eccentric column 108, and thus cutting the hair is achieved. In an embodiment, the eccentric wheel 108 is in transmission connection with the driving member 102, and the driving member 102 will bring the eccentric column 108 to rotate; since the eccentric column 1082 is provided at one side of the eccentric wheel 108, the movable blade 132 is provided with the first limiting hole 1324, through extending the eccentric column 1082 into the first limiting hole 1324, the movable blade 132 can be made to move along the second direction during the rotating. And the movable blade 132 extends along the second direction, the first limiting hole 1324 extends along a first direction perpendicular to the second direction, for example, the movable blade 132 moves laterally, the first limiting hole 1324 is arranged vertically, and the eccentric column 1082 will cooperate with the first limiting hole 1324 when the eccentric wheel 108 rotates, and then the movable blade 132 is made to move along the second direction. It needs to be emphasized that the cushion block 109 is provided at the side of the movable blade 132 away from the fixed blade 131, through providing the driven part 1092 on the cushion block 109, when the eccentric column 1082 brings the movable blade 132 to move, it will further bring the cushion block 109 to move under the effect of the driven part 1092; it can be understood that the cushion block 109 moves together with the movable blade 132, providing the cushion block 109 on the movable blade 132 can increase the contact area between the eccentric column and the movable blade 132, therefore the torque acting on the movable blade 132 is reduced, that is, the force totally acts on the movable blade 132, and the thicker the movable blade 132 is, the higher the transmission efficiency of the force is and the smaller the abrasion is, however, what follows is the increase of the thickness of the single movable blade 132, and this does not help processing, while the present disclosure connects the cushion block 109 with the movable blade 132 through providing the cushion block 109 on the movable blade 132, uses the cushion block 109 to increase the contact area between the movable blade 132 and the eccentric column 1082 in a changed way, and then the lowering of abrasion is achieved.

In some embodiments, a first housing 2062 and a second housing 2064 are provided, to provide space for the fixed blade 131, the movable blade 132 and the cushion block 109, and in an embodiment, the fixed blade 131 is fixed on the first housing 2062, the movable blade 132 and the cushion block 109 are located in a space formed by the connection between the first housing 2062 and the second housing 2064.

Furthermore, a first pin hole 2102 is provided in the two housings and the fixed blade 131, and a second pin hole 2104 is provided in the movable blade 132; when a connecting member 2106 passes through the first pin hole 2102 in the above three structures, its position is fixed, and meanwhile, under the cooperation between the connecting member 2106 and the second pin hole 2104, the moving range of the movable blade 132 will be limited, and the movable blade 132 can only do reciprocating motion along the extending direction of the second pin hole 2104, i.e., the second direction.

And the connecting member 2106 is a pin.

In a specific embodiment, the position of the fixed blade 131 only has one type, it is provided on the first housing 2062, and there can be one fixed blade or multiple fixed blades.

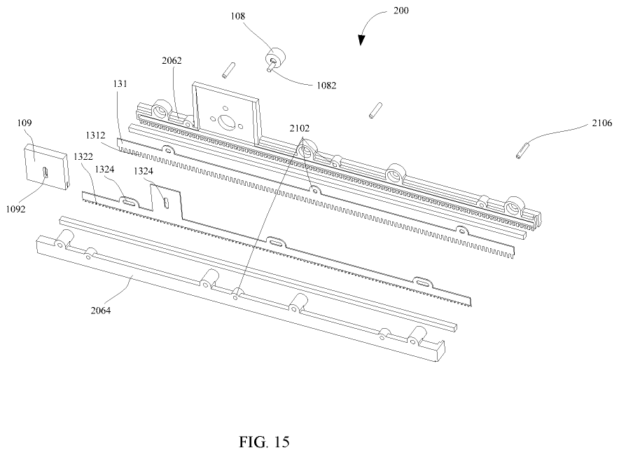

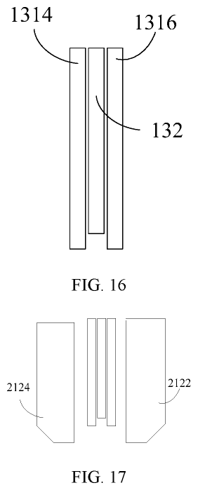

In a specific embodiment, the fixed blades 131 can be divided into two types based on the positions, as shown in FIG. 16, i.e., the first blade 1314 and the second blade 1316, and the two types of fixed blades 131 are respectively fixed on the first housing 2062 and the second housing 2064; through providing the movable blade 132 between the two types of fixed blades 131, both of the two types of fixed blades 131 can have a protection function for the movable blade 132. That is, when hard granular wastes such as stones appear, the fixed blade 131 has a stronger impact resistance as its position is fixed, through providing the first blade 1314 and the second blade 1316 respectively at the two sides of the movable blade 132, the wastes will first contact with the fixed blade 131, which does not move, from whatever direction, to protect the movable blade 132 and lower the damage of the wastes to the blades.

In some embodiments, considering the cutting effect of the fixed blade 131 and the movable blade 132 to the fibrous wastes, the size of the occupied space, the protection degree to the movable blade 132, the costs and other factors, the number of the fixed blade 131 and the number of the movable blade 132 are disposed flexibly based on actual needs.

On the basis of any of the above embodiments, the fixed blade 131 is provided with the first cutter tooth 1312, the movable blade 132 is provided with the second cutter tooth 1322, the first cutter tooth 1312 and the second cutter tooth 1322 are respectively provided at the same side of the fixed blade 131 and the movable blade 132, for example, the fixed blade 131 is provided at the lower side of the first cutter tooth 1312, the movable blade 132 is provided at the lower side of the second cutter tooth 1322, and thus cutting the hair is achieved when the movable blade 132 is driven to do reciprocating motion with respect to the fixed blade 131. It needs to be emphasized that in this solution, the first cutter tooth 1312 and the second cutter tooth 1322 are arranged at an interval, and meanwhile each first cutter tooth 1312 is provided corresponding to one second cutter tooth 1322, during the reciprocating motion of the movable blade 132, the motion route of the second cutter tooth 1322 will be located between two corresponding first cutter teeth 1312, and cutting the hair is achieved by the shortest route.

In addition, in this solution the positions of the first cutter tooth 1312 and the second cutter tooth 1322 are not arranged uniformly, while are arranged in an irregular staggered corresponding relation, that is, there is a distance difference between the left side of the first cutter tooth 1312 and the left side of the second cutter tooth 1322, the distance difference can fluctuate between 0.1 mm and 2 mm, for the first cutter tooth 1312 and the second cutter tooth 1322, using a non-uniform distribution can improve the cutting effect to the hair.

It can be understood that the first cutter tooth 1312 and the second cutter tooth 1322 are all located outside the first housing 2062 and the second housing 2064, and thus cutting the outside hair is achieved.

And the edge of the first cutter tooth 1312 on the fixed blade 131 can choose to be cut at one side or at two sides based on the position of the fixed blade 131.

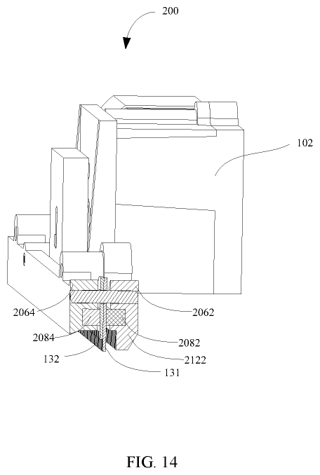

In addition, as shown in FIG. 14, a support member 2082 is provided in the first housing 2062, a sliding bar 2084 is provided in the second housing 2064, and under the effect of the support member 2082, the fixed blade 131 and the movable blade 132 are in a closely attached state, and meanwhile, under the effect of the sliding bar 2084, the movable blade 132 will slide more smoothly.

In an embodiment, a first comb tooth 2122 is provided at one end of the first housing 2062.

In another embodiment, a second comb tooth 2124 is provided at one end of the second housing 2064.

As shown in FIG. 17, in another embodiment, the first comb tooth 2122 is provided at one end of the first housing 2062, and meanwhile the second comb tooth 2124 is provided at one end of the second housing 2064.

As shown in FIG. 22, the hair cutting assembly 100 according to an embodiment provided by the present disclosure mainly comprises the driving member 102, the active member 104 and the transmitting wheel 106, the driving member 102 plays a role of providing an active force, the active member 104 and the transmitting wheel 106 are used as retarders and finally convert the rotation of the driving member 102 into the lateral driving to a transmitting rod 4110. In an embodiment, the active member 104 is directly sleeved on the driving shaft 1022, the driving shaft 1022 rotates and will bring the active member 104 to rotate at the same time, under the effect of the engagement of the active member 104 and the transmitting wheel 106, the transmitting wheel 106 is further made to rotate.

In one embodiment, the eccentric column 1082 is directly connected to the movable blade, to bring the movable blade 132 to move laterally.

In another specific embodiment, the transmitting rod 4110 is further provided, the indirect connection between the eccentric column 1082 and the movable blade 132 can be achieved through the transmitting rod 4110, the axis of the transmitting wheel 106 is not parallel to the axis of the driving shaft 1022, and in the case that the transmitting rod 4110 extends along the second direction, the axis of the transmitting wheel 106 and the transmitting rod 4110 will be staggered.

In some embodiments, in the case that the transmitting rod 4110 extends along the second direction, the axis of the transmitting wheel 106 is still not parallel to the transmitting rod 4110, and on this basis, as the structure of the active member 104 is adopted, the axis of the active member 104 can be made to be parallel to the extending direction of the transmitting rod 4110 substantially, thus this will limit the position of the driving member, and the driving member is staggered in a direction substantially perpendicular to the extending plane of the transmitting rod 4110, and by the substantially parallel position, the size of the overall driving member in a thickness direction, that is, the size in the axial direction of the transmitting wheel 106, is reduced in a certain extent.

And the connection between the active member and the driving shaft is a sleeved arrangement, i.e., the active member is sleeved on the driving shaft.

It needs to be emphasized that the cross section of the limiting hole can be an ellipse, or can be a runway type, and apparently, the limiting hole can be a through hole, the transmitting rod directly passes through, or the limiting hole can be a blind hole, and has certain limiting function to the transmitting rod.

It needs to be supplemented that the eccentric column 1082 and the transmitting rod 4110 are further provided, the movable blade 132 will be brought to do reciprocating motion under the effect of the transmitting rod 4110, and thus cutting the hair is achieved; through extending the eccentric column 1082 into a limiting hole 41102 extending along the first direction, when the eccentric wheel 108 rotates, the motion track of the eccentric column 1082 presents a circular shape; since the limiting hole 41102 extends along the first direction, the eccentric column 1082 will bring the limiting hole 41102 to move laterally, and furthermore, the transmitting rod 4110 can bring the movable blade 132 to do reciprocating motion in the second direction, to help achieve cutting the hair.

In some embodiments, the driving member 102 can adopt an ordinary motor or a gear motor.

And the first direction of the transmitting rod 4110 is the extending direction of the limiting hole 41102, and in a specific embodiment, the first direction is an upper and lower direction, the second direction is the extending direction of the transmitting rod 4110, and in other words, the first direction and the second direction are both the radial direction of the transmitting wheel 106, and the first direction is perpendicular to the second direction.

In some embodiments, the driving shaft 1022 extends along the second direction, and the driving member 102 is arranged parallel to the transmitting rod 4110, and thus the lateral space of the transmitting rod 4110 is configured to accommodate the driving member 102, and further reduce the size of the entire hair cutting assembly 100 in the thickness direction, i.e., the size of the transmitting wheel 106 in the axial direction is reduced to a degree.

And the driving shaft 1022 is a main structure for the driving member 102 to transmitting the torque to the outside, the entire structure of the driving member 102 is provided generally around the driving shaft 1022, and thus, through limiting the extending direction of the driving shaft 1022, the position of the driving member 102 can be limited, and furthermore, the size of the entire hair cutting assembly 100 in the thickness direction can be reduced.

And the eccentric wheel 108 coaxially connected to the transmitting wheel 106 is provided, and this can reduce the space occupation in the radial direction, i.e., the transmitting wheel 106 will directly bring the eccentric wheel 108 to rotate when it is driven by the active member 104, and since the eccentric column 1082 is provided at the side of the eccentric wheel 108 away from the transmitting wheel 106, the eccentric wheel 108 can be a round wheel, or a cam, as long as the center of gravity of the eccentric wheel 108 can be staggered with the rotation center. In other words, the straight line where the protruding direction of the eccentric column 1082 is located does not coincide with the rotating axis of the eccentric wheel.

It needs to be supplemented that the first direction is substantially perpendicular to the second direction, and the included angle between the first direction and the second direction can be in a range of 70°˜110°.

As shown in FIG. 22, the hair cutting assembly 100 provided according to an embodiment of the present disclosure mainly comprises the driving member 102, the active member 104, the transmitting wheel 106 and the transmitting rod 4110, the driving member 102 plays a role of providing an active force, the active member 104 and the transmitting wheel 106 are used as retarders and finally convert the rotation of the driving member 102 into the lateral driving to the transmitting rod 4110. In an embodiment, the active member 104 is directly sleeved on the driving shaft 1022, the driving shaft 1022 rotates and will bring the active member 104 to rotate at the same time, under the effect of the engagement of the active member 104 and the transmitting wheel 106, the transmitting wheel 106 is further made to rotate. In the present embodiment, the axis of the transmitting wheel 106 is perpendicular to the axis of the driving shaft 1022, and in the case that the transmitting rod 4110 extends along the second direction, the axis of the transmitting wheel 106 will be arranged perpendicular to the transmitting rod 4110, and on this basis, since the structure of the active member 104 is adopted, the axis of the active member 104 is parallel to the extending direction of the transmitting rod 4110, i.e., the axis of the active member 104 further extends along the second direction, and will further limit the position of the driving member 102, and it can be staggered in the direction perpendicular to the extending direction of the transmitting rod 4110, and through the use of the parallel position, the size of the entire hair cutting assembly 100 in the thickness direction, i.e., the size in the axial direction of the transmitting wheel 106, is reduced in a certain extent.

In some embodiments, a reduction housing 4112 is provided, and thus the structures such as the active member 104, the transmitting wheel 106 and the eccentric wheel 108 can be provided in the reduction housing 4112, and it is only necessary to respectively extend the eccentric column 1082 and the driving member 102 out of the reduction housing 4112, and in an embodiment, the eccentric column 1082 is provided facing the transmitting rod 4110, and the driving member 102 is provided at the side of the reduction housing 4112.

In an embodiment, a through hole is provided in the sidewall of the reduction housing facing the movable blade, and the eccentric wheel is provided in the through hole.

In another embodiment, the driving member 102 is located at the outer side of the reduction housing 4112.

In some embodiments, the driving member 102 is located at the outer side of the reduction housing along the second direction, and then this firstly reduces the volume of the reduction housing 4112 and secondly helps the heat dissipation of the driving member 102.

In addition, the transmitting shaft 4114 can further be provided to achieve the connection between the transmitting wheel 106 and the eccentric wheel 108, and in an embodiment, one end of the transmitting shaft 4114 is connected to the transmitting wheel 106, the transmitting wheel 106 will bring the transmitting shaft 4114 to rotate at the same time when it rotates, through extending the other end of the transmitting shaft 4114 into the eccentric wheel 108, the transmitting shaft 4114 drives the eccentric wheel 108 to rotate at the same time in the case that the transmitting shaft 4114 rotates, and furthermore, under the effect of the limiting hole 41102, the transmitting shaft 4110 will be driven to do straight line reciprocating motion along the second direction.

It needs to be supplemented that the cross section of the transmitting shaft 4114 can be a circular shape, or can be a bow shape, and even can be any polygon.

In an embodiment, the active member is a worm, the transmitting wheel 106 is a bevel gear cooperating with the active member 104, and under the effect of the driving of the active member 104, the rotating of the transmitting wheel 106 can be achieved.

In another embodiment, the active member is the worm, the transmitting wheel 106 can be a worm wheel, through the cooperation between the worm wheel and the active member 104, for the worm wheel and the active member 104, there is a self-locking function, only the active member 104 can be used as the active member to transmit the power to the worm wheel, while cannot transmit the power reversely, to improve the protection to the driving member 102.

In another embodiment, the active member is an angle gear, and the transmitting wheel is an angle gear.

In another embodiment, the active member is a spur gear, and the transmitting wheel is a crown gear.

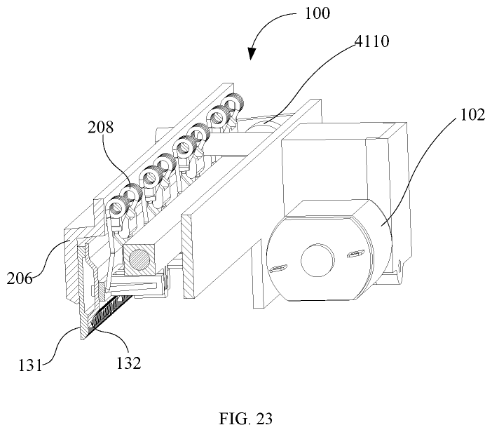

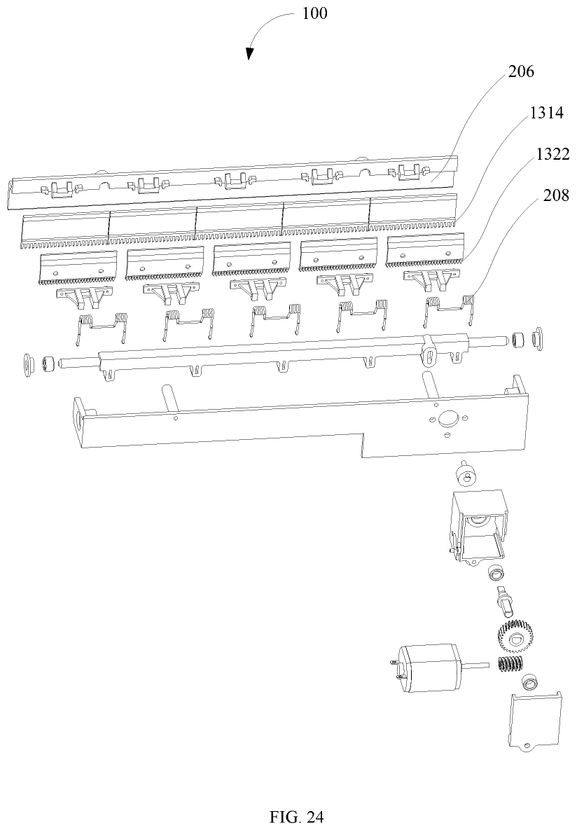

As shown in FIG. 23 and FIG. 24, the hair cutting assembly 100 provided in one embodiment of the present disclosure comprises: the fixed blade 131 and the movable blade 132 provided adjacent to each other, the driving member 102, the active member 104, the transmitting wheel 106 and the transmitting rod 4110; the position of the fixed blade 131 is fixed, for the movable blade 132, through the connection to the transmitting rod 4110, when the transmitting rod 4110 does a straight line reciprocating motion along the second direction, the movable blade 132 can be made to move with respect to the fixed blade 131, to achieve the effect of cutting the hair. The driving member 102 plays a role of providing an active force, the active member 104 and the transmitting wheel 106 are used as retarders and finally convert the rotation of the driving member 102 into the lateral driving to the transmitting rod 4110. In an embodiment, the active member 104 is directly sleeved on the driving shaft 1022, the driving shaft 1022 rotates and will bring the active member 104 to rotate at the same time, under the effect of the engagement of the active member 104 and the transmitting wheel 106, the transmitting wheel 106 is further made to rotate; since the axis of the transmitting wheel 106 is perpendicular to the axis of the driving shaft 1022, in the case that the transmitting rod 4110 extends along the second direction, the axis of the transmitting wheel 106 will be arranged perpendicular to the transmitting rod 4110, and on this basis, since the structure of the active member 104 is adopted, the axis of the active member 104 is parallel to the extending direction of the transmitting rod 4110, i.e., the axis of the active member 104 further extends along the second direction, and will further limit the position of the driving member 102, and it can be staggered in the direction perpendicular to the extending plane of the transmitting rod 4110, and through the use of the parallel position, the size of the overall hair cutting assembly 100 in the thickness direction, i.e., the size in the axial direction of the transmitting wheel 106, is reduced in a certain extent.

It needs to be supplemented that the eccentric wheel 108 and the transmitting rod 4110 are further provided, the movable blade 132 will be brought to do reciprocating motion under the effect of the transmitting rod 4110, and thus cutting the hair is achieved; the eccentric wheel 108 is coaxially connected to the transmitting wheel 106, and this can reduce the space occupation in the radial direction, i.e., the transmitting wheel 106 will directly bring the eccentric wheel 108 to rotate when it is driven by the active member 104 to rotate; since the eccentric wheel 108 is provided with a protrusion, i.e., the eccentric column 1082, at the side of the eccentric wheel 108 away from the transmitting wheel 106, through extending the eccentric column 1082 into the limiting hole 41102 extending along the first direction, when the eccentric wheel 108 rotates, the motion track of the eccentric column 1082 presents a circular shape; since the limiting hole 41102 extends along the first direction, the eccentric column 1082 will bring the limiting hole 41102 to move laterally, and furthermore, the transmitting rod 4110 is made to do reciprocating motion in the second direction.

It needs to be added that the fixed blade 131 and the movable blade 132 are provided adjacent to each other, to achieve the cutting under the effect of an edge portion when the movable blade 132 moves.

And the movable blade 132 is connected to the transmitting rod 4110, the driving member 102 is arranged parallel to the movable blade 132, the driving shaft 1022 will be parallel to the extending direction of the movable blade 132, and through using the space at the side surface of the movable blade 132, the size of the entire hair cutting assembly 100 in the thickness direction of the movable blade 132 can be reduced.

In some embodiments, the fixed blade 131 is provided with the first cutter tooth 1312, the movable blade 132 is provided with the second cutter tooth 1322, the first cutter tooth 1312 and the second cutter tooth 1322 are respectively provided at the same side of the fixed blade 131 and the movable blade 132, for example, the fixed blade 131 is provided at the lower side of the first cutter tooth 1312, the movable blade 132 is provided at the lower side of the second cutter tooth 1322, and thus cutting the hair is achieved when the movable blade 132 is driven to do reciprocating motion with respect to the fixed blade 131. It needs to be emphasized that in this solution, the first cutter tooth 1312 and the second cutter tooth 1322 are arranged at an interval, and meanwhile each first cutter tooth 1312 is provided corresponding to one second cutter tooth 1322, during the reciprocating motion of the fixed blade 132, the motion route of the second cutter tooth 1322 will be located between two corresponding first cutter teeth 1312, and cutting the hair is achieved by the shortest route.

And for the movable blade 132, the moving range of the second cutter tooth 1322 should not be less than the tooth distance of two corresponding first cutter teeth, i.e., the route of the second cutter tooth will pass a range corresponding to at least three first cutter teeth.

In an embodiment, the positions of the first cutter tooth 1312 and the second cutter tooth 1322 are not arranged uniformly, while are arranged in an irregular staggered corresponding relation, that is, there is a distance difference between the left side of the first cutter tooth 1312 and the left side of the second cutter tooth 1322, the distance difference can fluctuate between 0.1 mm and 2 mm, for the first cutter tooth 1312 and the second cutter tooth 1322, using a non-uniform distribution can improve the cutting effect to the hair.

And the distance between two adjacent first cutter teeth 1312 is a first tooth distance, correspondingly, there is a second tooth distance between two adjacent second cuter teeth 1322, and the absolute difference between the first tooth distance and the second tooth distance is 0.1 mm˜2 mm.

And the tooth width of the first cutter tooth 1312 is a first tooth width, the tooth width of the corresponding second cutter tooth 1322 is a second tooth width, and the absolute distance between the first tooth width and the second tooth width is 0.1 mm˜2 mm.

In some embodiments, a cutting housing 206 is further provided to provide a fixed position for the fixed blade 131, i.e., the fixed blade 131 is fixed on the cutting housing 206; through disposing sliding holes in the two opposite side walls of the cutting housing 206, it helps the right sliding and the left sliding of the transmitting rod 4110, and thus the movable blade 132 can be made to move with respect to the fixed blade 131, and further achieve cutting the hair.

It can be understood that the sliding holes are provided in the two side walls of the cutting housing 206, the side walls are arranged along the second direction, the two ends of the transmitting rod 4110 are respectively inserted into the sliding hole in one side wall, and thus, the transmitting rod 4110 can achieve the lateral reciprocating motion from the left to the right under the effect of the driving member 102, to conveniently achieve the cutting.

For the fixed blade 131 and the movable blade 132, in order to improve the cutting effect, as shown in FIG. 24, it is necessary to keep attaching the two to each other closely; in an embodiment, a torsion spring structure 208 is provided on the outer side of the movable blade 132, i.e., the side away from the fixed blade 131; the movable blade 132 can be disposed closely adjacent to the fixed blade 131 through the elastic force provided by a torsion spring, to improve the cutting effect to the hair.

In an embodiment, one of the fixed blade 131 and the movable blade 132 can be subjected to a magnetic treatment or directly made of a magnetic materials, and on this basis, a magnetic member can be provided at the outer side of the blade which is not subjected to the magnetic treatment, for example, the fixed blade 131 has a magnetic performance, the magnetic member is provided at the side of the movable blade 132 away from the fixed blade 131, and through the cooperation between the magnetic member and the fixed blade 131, the movable blade 132 can be compressed to the fixed blade 131 tightly.

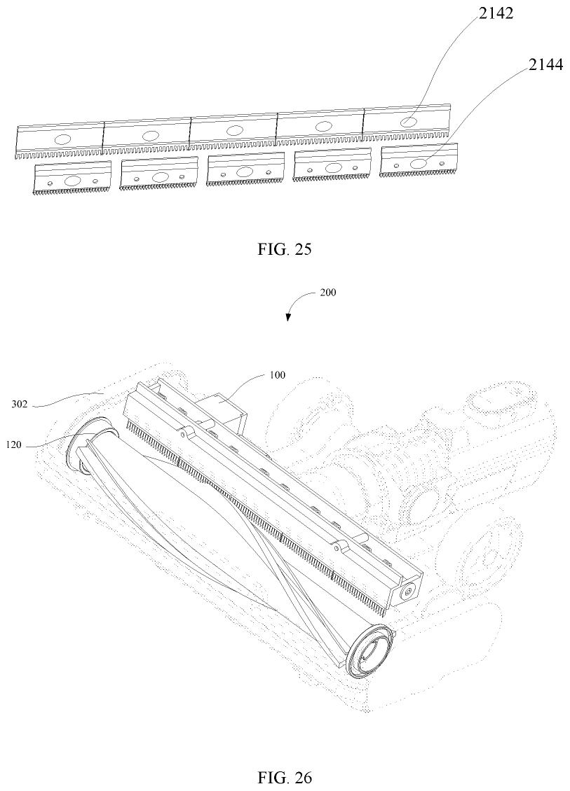

In another embodiment, as shown in FIG. 25, two types of magnetic members are respectively provided on the two types of blades, i.e., a first magnetic member 2142 is provided on the fixed blade 131, and a second magnetic member 2144 is provided on the movable blade 132, and thus the movable blade 132 can be attached to the fixed blade 131 through a magnetic force, and this helps the cutting. It needs to be explained that the magnetic member has an N pole and an S pole, and in this solution, in the process that the movable blade 132 conducts a straight line reciprocating motion, it is only necessary to ensure that the mutual attraction between the first magnetic member 2142 and the second magnetic member 2144 remains unchanged and will not be changed into a repulsive force.

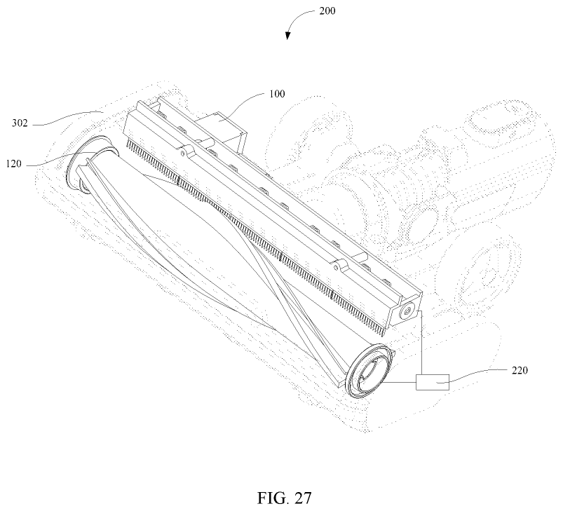

As shown in FIG. 26 and FIG. 27, an embodiment according to the present disclosure provides a cleaning device 200, including: a device housing 302 and the hair cutting assembly 100 provided in the device housing 302, through providing one or multiple rolling brushes 120 in the device housing 302, the hair on the rolling brush 120 can be cut through the hair cutting assembly 100 when the rolling brush 120 is wound by the hair on the ground, thus ensuring subsequent long-term cleaning effect.

And there can be one rolling brush 120, or multiple roller brushes.

In an embodiment, a structure with double rolling brushes 120 is adopted, and then, the hair cutting assembly 100 can be provided at the position corresponding to the two rolling brushes 120.

In another embodiment, a structure with a single rolling brush 120 is adopted.

And the cleaning device 200 comprises, while is not limited to, a vacuum cleaner, a floor scrubber, a sweeping robot and the like that can collect and clean the dust and hair on the floor.

In some embodiments, a controller 220 is provided to control the motion of the movable blade 132 and the rotation of the rolling brush 120, to improve the intelligence level of the product.

The embodiments of the present disclosure are described in detail in combination with the accompanying drawings, through the embodiments of the present disclosure, since the first distance is not zero, the cutting surface does not extend completely along the radial direction of the rolling bush; through limiting that the first distance is less than the maximum radius size of the rolling brush, when the rolling brush is wound by hair, it is more convenient to contact the cutting surface to cut, to ensure a long-term use of the hair cutting assembly.

In the specification of the present disclosure, the terms of “first”, “second” and “third” are used only for the purpose of description and shall not be understood to indicate or imply any relative importance; and the term of “multiple” indicates two or more, unless otherwise explicitly specified or defined; the terms of “mount”, “connected to”, “connect with”, “fixing” and the like should be understood in a broad sense, for example, the term “connected to” may be a fixed connection, and may further be a removable connection, or an integral connection; and the term of “connect with” may be a direct connection and may further be an indirect connection through an intermediate medium.

In the description of the present disclosure, it needs to be understood that the orientation or position relations indicated by the terms of “upper”, “lower”, “left”, “right”, “front”, “rear” and the like are based on the orientation or position relations shown in the accompanying drawings, and they are just intended to conveniently describe the present application and simplify the description, and are not intended to indicate or imply that the devices or units as indicated should have specific orientations or should be configured or operated in specific orientations, and then should not be construed as limitations to the present application.

In the description of the present specification, the descriptions of the phrases “one embodiment”, “some embodiments” and “specific embodiments” and the like mean that the specific features, structures, materials or characteristics described in combination with the embodiment(s) or example(s) are included in at least one embodiment or example of the present disclosure. In the specification, the schematic representation of the above phrases does not necessarily refer to the same embodiment or example. Moreover, the particular features, structures, materials or characteristics described may be combined in a suitable manner in any one or more of the embodiments or examples.

1. A hair cutting assembly, comprising:
a housing;
a rolling brush connected to the housing, wherein the rolling brush comprises a rotating axis and is able to rotate with respect to the housing along the rotating axis;
a fixed blade, connected to the housing, wherein the fixed blade is fixed relative to the housing;
a movable blade, connected to the housing, wherein the movable blade is able to move with respect to the fixed blade, and the fixed blade is adjacent to the movable blade with respect to the circumferential direction of the rolling brush;
wherein, in the cross section of the rolling brush, a sixth distance between the rotating axis and a plane where the fixed blade abuts on the movable blade is less than a maximum radius size of the rolling brush, and the sixth distance is not zero.

2. The hair cutting assembly according to claim 1, wherein, the rolling brush comprises:
a roller;
at least one row of bristles, provided on the roller in a spiral shape;
at least one sheet, provided on the roller and parallel to the bristles;
wherein, in the cross section of the rolling brush, a second distance between the position of the end portions of the fixed blade and the movable blade which extend to the rolling brush and the rotating axis is greater than a second maximum radius size of the sheet with respect to the rotating axis, and less than a first maximum radius size of the bristles with respect to the rotating axis.

3. The hair cutting assembly according to claim 2, further comprising:
a comb tooth, provided on the housing, wherein the movable blade and the comb tooth are respectively provided at the two sides of the fixed blade;
wherein, the circumferential angle presented between the end of the comb tooth facing the rolling brush and the end of the fixed blade facing the rolling brush, and the rotating axis of the rolling brush is not greater than 25 degrees.

4. The hair cutting assembly according to claim 2, wherein, in the cross section of the rolling brush, at the intersection of the straight line of the extending direction of the movable blade and the cross section of the rolling brush, the included angle between the tangent line in the rotating direction of the rolling brush and the extending direction of the movable blade is an acute angle.

5. The hair cutting assembly according to claim 1, wherein, the ratio of the maximum radius size to the sixth distance is not less than 1.1.

6. The hair cutting assembly according to claim 1, further comprising:
a plurality of first cutter teeth, provided on a side of the fixed blade facing the rolling brush, wherein any two adjacent first cutter teeth are arranged at an interval;
a plurality of second cutter teeth, provided at a side of the movable blade facing the rolling brush, wherein any two adjacent second cuter teeth are arranged at an interval;
wherein, each of the first cutter teeth is arranged corresponding to one second cutter tooth, and the distance difference between the first cutter tooth and the second cutter tooth, which correspond to each other, at the same side is within a range of 0.1 mm˜2 mm.

7. The hair cutting assembly according to claim 6, wherein, in the cross section of the rolling brush, a distance between the end of the first cutter tooth facing the rolling brush and the rotating axis is a fourth distance, and when the movable blade is at a first working position, a distance between the end of the second cutter tooth facing the rolling brush and the rotating axis is a fifth distance, and when the movable blade is at a second working position, a distance between the end of the second cutter tooth facing the rolling brush and the rotating axis is a third distance, the fifth distance is greater than the fourth distance, and the third distance is greater than the fourth distance;
wherein, the fifth distance is greater than the third distance, and the difference between the third distance and the fourth distance is not less than 0.1 mm;
wherein, the fourth distance is not greater than the maximum radius size of the rolling brush, and the difference between the fourth distance and the maximum radius size is not greater than 5 mm; the third distance is not less than the maximum radius size, and the difference between the third distance and the maximum radius size is not greater than 5 mm;
wherein, the fourth distance is not less than the maximum radius size of the rolling brush and the difference between the fourth distance and the maximum radius size is not greater than 5 mm.

8-10. (canceled)

11. A hair cutting assembly, comprising:
a housing;
a rolling brush, connected to the housing, wherein the rolling brush is able to rotate along a rotating axis with respect to the housing;
a fixed blade, connected to the housing, wherein the fixed blade is fixed with respect to the housing; and
a movable blade, connected to the housing, wherein the movable blade is able to move with respect to the fixed blade, the fixed blade is adjacent to the movable blade with respect to the circumferential direction of the rolling brush; when the plane where the rotating axis is located rotates with the rolling brush along a first rotating direction, the plane passes the fixed blade and the movable blade successively.

12. The hair cutting assembly according to claim 11, wherein, at least one fixed blade is provided at the side of the movable blade along the circumferential direction, and at least one fixed blade is provided at the other side of the movable blade along the circumferential direction, in the process of rotating with the rolling brush along a second rotating direction, before passing the movable blade, the plane passes at least one fixed blade, and the second rotating direction is opposite to the first rotating direction.

13. The hair cutting assembly according to claim 11, wherein, the tooth tip side of the fixed blade is disposed facing the rolling brush, the tooth tip side of the movable blade is disposed facing the rolling brush, the movable blade comprises a first working position and a second working position, the movable blade is able to move from the first working position to the second working position or from the second working position to the first working positions:
wherein, a distance between the tooth tip side of the fixed blade and the rotating axis is a first distance, a distance between the tooth tip side of the movable blade which is located at the first working position and the rotating axis is a second distance, a distance between the tooth tip side of the movable blade which is located at the second working position and the rotating axis is a third distance, the second distance is greater than the first distance, and the third distance is greater than the first distance;
wherein, the second distance is greater than the third distance, and the difference between the third distance and the first distance is not less than 0.1 mm,
wherein the first distance is not greater than the maximum radial size of the rolling brush, and the difference between the first distance and the maximum radial size is not greater than 5 mm, the third distance is not less than the maximum radial size, and the difference between the third distance and the maximum radial size is not greater than 5 mm;
wherein, the first distance is not less than the maximum radial size of the rolling brush and the difference between the first distance and the maximum radial size is not greater than 5 mm.

14-17. (canceled)

18. The hair cutting assembly according to claim 11, further comprising:
a shielding portion, connected to the housing, wherein the shielding portion is provided at the side of the fixed blade away from the movable blade;
a guiding portion, connected to the shielding, portion, wherein the guiding portion extends towards a direction away from the fixed blade;
wherein, the number of the rolling brush is at least one, the fixed blade and the movable blade form a blade assembly, the number of the blade assembly is at least one, and the number of the rolling, brush is not less than the number of the blade assembly.

19-20. (canceled)

21. A hair cutting assembly, used in a cleaning device, comprising:
a driving member, provided with an eccentric column at one side;
a movable blade, in transmission connection with the driving member through the eccentric column;
a cushion block, provided on the movable blade and provided with a driven part, wherein the eccentric column extends into the driven part or extends into a first limiting hole of the movable blade and the driven part.

22. The hair cutting assembly according to claim 21, wherein, a protruding portion which is adaptive to the shape of the first limiting hole is provided on the driven part, the protruding portion is provided with a second limiting hole therein, the protruding portion extends into the first limiting hole, and the eccentric column passes through the second limiting hole,
wherein, the movable blade is inserted into the cushion along a first direction, a third limiting hole which is provided opposite to the first limiting hole is provided in the driven part, and the third limiting hole is adaptive to the shape of the first limiting hole;
wherein, the driven part is provided with a fourth limiting hole, and the eccentric column is located inside the fourth limiting hole,
further comprising: an eccentric wheel, in transmission connection with the driving member wherein the eccentric column is provided at the side of the eccentric wheel away from the driving member;
wherein, the size of the eccentric column is greater than the size of the eccentric wheel; or
the size of the eccentric column is smaller than the size of the eccentric wheel, a bearing is sleeved on the eccentric column, and the bearing; is provided inside the fourth limiting hole.

23-26. (canceled)

27. The hair cutting assembly according to claim 21, further comprising:
a first housing, wherein a fixed blade is provided on the first housing; and
a second housing, detachably connected to the first housing, wherein the movable blade and the cushion block are located between the first housing and the second housing;
a first pin hole, provided in the first housing, the fixed blade and the second housing;
a second pin hole, provided in the movable blade, wherein the second pin hole extends along a second direction; and
a connecting member, passing through the first pin hole and the second pin hole;
a support member, provided in the first housing, wherein one side of the support member abuts on the fixed blade; and
a sliding bar, provided in the second housing, wherein one side of the sliding bar abuts on the movable blade.

28. (canceled)

29. The hair cutting assembly according to claim 27, wherein, the fixed blade comprises a first blade and a second blade, the first blade is fixed on the first housing, the second blade is fixed on the second housing, and the movable blade is provided between the first blade and the second blade.

30. (canceled)

31. A hair cutting assembly, comprising:
a driving member;
an active member, connected to the driving shaft of the driving member;
a transmitting wheel, engaging with the active member, wherein the axis of the transmitting wheel is not parallel to the axis of the driving shaft;
an eccentric column, connected to the transmitting wheel;
a movable blade, provided on the eccentric column;
wherein, the transmitting wheel rotates and makes the movable blade do reciprocating motion through the cooperation of the movable blade and the eccentric column.

32. The hair cutting assembly according to claim 31, further comprising:
a transmitting rod, provided with a limiting hole for the passing through of the eccentric column, wherein the limiting hole extends in a first direction of the transmitting rod, the transmitting rod extends along a second direction, and the first direction is substantially perpendicular to the second direction;
wherein, the movable blade is provided on the transmitting rod, the transmitting rod rotates, and the cooperation of the limiting hole and the eccentric column makes the transmitting rod bring the movable blade to do reciprocating motion along a straight line where the second direction is located.

33. The hair cutting assembly according to claim 31, further comprising:
a reduction housing, provided with the active member and the transmitting wheel;
wherein the driving member is located at the outer side of the reduction housing;
further comprising: an eccentric wheel, in coaxial connection with the transmitting wheel, wherein the eccentric column is provided at the side of the eccentric wheel away from the transmitting wheel;
wherein, a through hose is provided in the side wall of the reduction housing, facing the movable blade, and the eccentric wheel is located within the through hole; and/or
the driving member is located at the outer side of the reduction housing in a second direction;
wherein the active member is a worm, and the transmitting wheel is a bevel gear, or
the active member is the worm, and the transmitting wheel is a worm wheel, or
the active member is an angle gear, and the transmitting wheel is an angle gear; or
the active member is a spur gear, and the transmitting wheel is a crown gear.

34-37. (canceled)

38. The hair cutting assembly according to claim 31, further comprising:
a fixed blade, wherein the fixed blade and the movable blade are adjacently arranged;
a plurality of first cutter teeth, provided on the fixed blade, wherein any two adjacent first cutter teeth are arranged at an interval; and
a plurality of second cutter teeth, provided the movable blade, wherein any two adjacent second cuter teeth are arranged at an interval;
wherein, each of the first cutter teeth is arranged corresponding to one second cutter tooth, and the distance difference between the first cutter tooth and the second cutter tooth, which correspond to each other, at the same side is within a range of 0.1 mm˜2 mm;
a torsion spring structure, provided on the side of the movable blade away from the fixed blade, wherein the torsion spring structure is configured to compress the movable blade to the fixed blade tightly.

39-41. (canceled)

42. A cleaning device, comprising:
the hair cutting assembly according to claim 1;
a first driving member, connected to the rolling brush of the hair cutting assembly, wherein the first driving member is configured to drive the rolling brush to rotate along its axis;
a second driving member, connected to the movable blade of the hair cutting assembly, wherein the second driving member is configured to drive the movable blade to move with respect to the fixed blade of the hair cutting assembly; and
a controller, connected to the first driving member, wherein the controller is connected to the second driving member.

43. The cleaning device according to claim 42, further comprising:
a detecting device, connected to the controller, and configured to detect the amount of the wastes that are adhered to or wind the rolling brush,
wherein, the controller is configured to determine that the rolling brush of the cleaning device is in a working state, and limit the movable blade to be in a moving state when the detecting device determines that the amount of the wastes on the rolling brush is greater than a first threshold; or
the controller is configured to limit the movable blade to be in a moving state, and limit the movable blade to stop moving when the detecting device determines that the amount of the wastes on the rolling brush is less than a second threshold, and the second threshold is not greater than the first threshold;
wherein, the detecting device is connected to the housing of the hair cutting assembly, and the detecting device is an optical recognition camera; or
the detecting device is connected to the first driving member and is configured to detect the current value of the first driving member.

44. The cleaning device according to claim 43, wherein, the detecting device is connected to the housing of the hair cutting assembly, and the detecting device is an optical recognition camera; or
the detecting device is connected to the first driving member and is configured to detect the current value of the first driving member.

45. The cleaning device according to claim 42, further comprising:
a first storage container, connected to the housing of the hair cutting assembly, wherein the first storage container is configured to store a cleaning liquid, and communicates with the cavity of the hair cutting assembly; and
a second storage container, connected to the housing, wherein the second storage container is configured to store the wastes and sewage, and communicates with the cavity of the hair cutting assembly.

46. A cutting control method, used for the cleaning device of claim 42, wherein the cutting control method comprises:
acquiring the operating mode of the cleaning device;
determining the rotating parameters of the rolling brush and the motion parameters of the movable blade according to the operating mode;
controlling the rotation of the rolling brush through the first driving member according to the rotating parameters; and
controlling the motion of the movable blade with respect to the fixed blade through the second driving member according to the motion parameters.

47. The cutting control method according to claim 46, further comprising:
determining the amount of the wastes adhered to or winding the rolling brush by the detecting device;
determining that the rolling brush is in a working state, and limiting the movable blade to be in a moving state when the amount of the wastes on the rolling brush determined by the detecting device is greater than a first threshold; or
limiting the movable blade to be in a moving state, and limiting the movable blade to stop moving when the amount of the wastes on the rolling brush detected by the detecting device is less than a second threshold;
wherein the second threshold is not greater than the first threshold.
